(19) United States
(12) Patent Application Publication
(10) Pub. No.: US 2002/0076015 A1
(43) Pub. Date: Jun. 20, 2002

(54) Comprehensive message communication system

(76) Inventors: Grant N. Norwitz, Seattle, WA (US); David M. Bartosh, Seattle, WA (US); Noah V. Collins, Seattle, WA (US); Jonathan S. Wilzig, Seattle, WA (US)

Correspondence Address: Clark A. Puntigam, JENSEN & PUNTIGAM, P.S., 1020 United Airlines Bldg., 2033 Sixth Avenue, Seattle, WA, 98121-2584, US

(21) Appl. No.: 09/738,154

(22) Filed: Dec. 15, 2000

(51) Int. Cl. H04M 11/00

(52) U.S. Cl. 379/93.09

(57) ABSTRACT

The communication system includes an integrated voice (telephone) portion and a network portion connected to each other through a single, common database, where all message and event information is stored. The system recognizes and permits responses by users to incoming telephone calls, voice, E-mail messages and FAX messages. The system permits users in a subscribing organization to communicate with other users with respect to possible tasks and appointments and other events within the organization. The system maintains a calendar and task list for each user as well as group calendars for the subscribing organization.

### TECHNICAL FIELD

This invention relates generally to message communication systems, and more specifically concerns such a system which encompasses several communication modes, including E-mail, voice, both direct calls and messages, and facsimile, in one integrated system, and which further includes schedule/calendar information, the system being useful for both organizations and individuals.

### BACKGROUND OF THE INVENTION

Traditionally, communication systems have been quite device-dependent, with individual devices in the system being connected through a switching or network system. Most such communication systems have typically involved individual pieces of equipment for a single mode of message communication, i.e. voice (telephone), facsimile and/or E-mail. This is true of even the more modern communication systems, although some systems include several communication modes which, however, are still typically independent, in function and data management, of each other within the overall system. In these systems, direct contact can be made by voice (telephone), and/or messages can be received and left for the user to return (voice mail, E-mail and FAX mail). Other device capability includes wireless and two-way pagers.

While in some cases these newer systems provide an extensive communication capability, they still use separate devices with separate databases for receiving and playing messages, and provide for return messaging only via the same communication mode, i.e. a reply to an E-mail message will be an E-mail message. However, an integrated communication system is a desirable goal, encompassing traditional modes of communication, including voice, E-mail and FAX, with an opportunity to respond in a variety of modes, while also permitting collaboration between users. Also, it is desirable to have calls and messages follow the party being contacted to various locations, through various phone numbers and communication modes, as determined by specific selections (instructions) of that party.

The lack of significant integration between the various modes of communication, particularly the significant difference between telephone-based and network-based (i.e. internet) communication systems, often adds significantly to the overall complexity and expense of a comprehensive communication system. Reliability is also typically a concern in existing systems, as well as a lack of flexibility in operation and choices available to the user.

In addition, such conventional communication systems are often used in conjunction with a separate, independent communication system for users within a given organization. Such intra-organizational communication systems, while providing voice and perhaps E-mail capability, are usually quite limited in their functionality and do not provide for contacts for appointments, tasks and other intracompany scheduling capability.

Accordingly, there is a need for a completely integrated communication system having the ability to communicate in various modes, as well as providing the ability to make intra-organizational contacts, including scheduling of tasks and appointments, and the ability to follow a called party within the organization, in accordance with the called party's preferences.

### DISCLOSURE OF THE INVENTION

Accordingly, one aspect of the present invention is a communication system which comprises: means for recognizing an incoming telephone call and routing it to a selected user in a user (subscribing) organization which is using the system; means for receiving a telephone message and routing it to a selected user in the user organization; means for recognizing an incoming email message and routing it to a selected user in the user organization; means for recognizing an incoming FAX message and routing it to a selected user in the user organization; means enabling users in the user organization to respond to telephone calls, email and FAX messages directed to them; means permitting the user in the user organization to communicate with other users in the user organization regarding possible appointments and tasks within the user organization; means for connecting the system to a global computer network so that users in the user organization have access to the communication system via said network; processing means for maintaining operating control over the communication system; and a single database means for storing messages and other data relating to the communication system.

Another aspect of the invention is a communication system which comprises: means for recognizing incoming telephone calls and telephone, email and FAX messages to a selected user in a user organization and routing said calls and messages to said selected user; means for storing said messages in and retrieving said messages from a single system database; means enabling said selected user to respond said messages; and means in the database for co-relating messages from a sending party with information in the database concerning the sending party and providing said information to said selected user.

Still another aspect of the present invention system is a communication system which comprises means for recognizing incoming telephone calls and telephone, email and FAX messages to a selected user in a user organization and routing said calls and messages to said selected user; means for storing said messages in and retrieving said messages from a single system database; means enabling said selected user to respond to said messages; and means for storing information concerning users in the user organization, and other selected contact individuals, in the system database, wherein said stored information is related to other selected information in the database by an identification of the user or other contact individual associated with said stored information.

A further aspect of the invention is a communication system which comprises: means for recognizing incoming telephone calls and telephone, email and FAX messages to a selected user in a user organization and routing said messages to said selected user; means for storing said messages in and retrieving messages from a single system database; means enabling said selected user to respond to said messages; means for receiving and connecting an incoming telephone call to a called selected user, upon acceptance of the call by the called user; and means for establishing and maintaining a calendar of accepted appointments and tasks for each user in the user organization, wherein the calendar information is integrated with the message information in the system database relative to each user.

A still further aspect of the present invention is a system for updating time zones information for use in a communication system which involves various modes of communication relative to individual users in an organization, comprising: means in a system database for maintaining the time zones of the location of the individual users in the communication system; means for controlling the routing of messages to individual users based on the time zone location of the users, in accordance with pre-determined criteria, and means for establishing a new time zone for a user, wherein the controlling means thereafter controls the routing of messages based on the new time zone.

### BRIEF DESCRIPTION OF THE DRAWINGS

FIGS. 1-3 are high level organization and data flow diagrams of the overall system of the present invention.

FIGS. 4-34 are detailed process diagrams for the telephone portion of the present invention as well as some general process diagrams.

FIGS. 35-48 are detailed process diagrams for the network (internet) portion of the present invention as well as some additional general process diagrams.

### BEST MODE FOR CARRYING OUT THE INVENTION

The present invention is a completely integrated communication message system involving various modes of communication. The modes include voice, both calls and messages, E-mail and FAX messages, the messages being stored as individual records and in different relational tables, within a single relational database. The system includes an arrangement of several data flow sequences, relative to the database, as discussed in detail below. All of the physical data for the system is maintained within the single database, with the individual tables in the database providing significant scalability, with capability of replication. The system users have full access to and control of their database information via various network (visual presentation layer) interface devices, such as a PC, hand-held device, etc. An IVR (interactive voice response) interface is provided for voice/text interchangeability of data.

As discussed in more detail below, system “contact” individuals are “stored” within the database by assigned name or unique identifier (ID) and related in the database to key pieces of information about those individuals. Information in the database concerning sources of messages is made available to a called party by searching those contact records, for reply or other use of the message. Such information includes, for example, phone numbers and E-mail addresses.

The integration of the data is complete within the single relational database, since all the individual messages are stored as separate records in tables. Other types of data properties, including schedule items, tasks, group meetings and user preferences, can be related to messaging, as separate records, within the database. Hence, the various data properties are separate by means of the separate records but are integrated via the relationship between them. Incoming messages, such as E-mail, are connected or related to previously stored information about the sender, so that the individual user/receiver within the system has the ability to quickly obtain information about the sending party, regardless of whether the sender is within or outside of the user's organization. The system of the present invention has the capability of scheduling appointments, events, tasks and management requirements for individual system users combined with a complete incoming direct voice and messaging system involving various modes of communication and the ability to respond in various communication modes. All of this capability can be linked to individual users within an organization by a single telephone number and E-mail address for each user, with information for and about the user being related to the name of the individual user. It is possible for users to have more than one telephone number and/or E-mail address.

Individual groups of users within an organization can be grouped together and/or disbanded with the system of the present invention by an individual user of the system. Invitations can be issued by individual users to other individual users within the user organization, within separate groups (departments) within the organization, or even outside of the organization. Individual data elements are controlled and protected in various ways, including encryption and decryption of the various communication transactions. Records of invitations and responses are also available at the database level. Archiving of selected data is also possible, with the use of peripheral devices.

The system of the present invention includes a telephone-based portion, so that contact with individual users in using organizations can be made over conventional telephone lines. Such telephone contact includes direct voice, voice messaging and FAX messages. Replies to FAX messages can be made using the individual user's voice. The present system also includes a network, i.e. internet, portion, where messages can be provided to individual users and reply messages provided via network-connected devices. Use of voice recognition techniques, conventional or otherwise, in the present system provides a voice-text interchangeability. Further, the system permits responses to calls and messages through a variety of communication modes.

The system can be used by organizations of various sizes, from relatively small to quite large, referred to as user or subscribing organizations, and has the capability of receiving messages at one or more phone numbers and one or more E-mail addresses which can then be used to follow individual users within a using organization anywhere in the world. Individual users can access their messages in the system and respond through telephone or a network device, such as a PC, cell phone, laptop, palm-held or other device. The system can also be used by a single individual. This fully integrated, interactive communication system is implemented by a combination of software and hardware systems, including a single relational database containing all the data for each using organization and the individual users therein.

The present system also has encryption capability to maintain security within the system for the various user organizations as well as communication between the system and the external world.

All data within the system, as indicated above, is contained within a single database. The following explanation is in the context of a single user organization, but it should be understood that the system is designed to operate with individual users as well as organizations of various sizes. The database is arranged such that each message or schedule item (such as an appointment or assigned task) is stored in the database as an individual record, in a different relational table. The arrangement in one embodiment includes over 60 tables and a large number of data sequences, as well as a large number of rules for dealing with the data. These rules or procedures are also contained within the database. The following information on the flow of data and operations within the system can be accomplished with various database design approaches, within the above parameters, by one skilled in the applicable art.

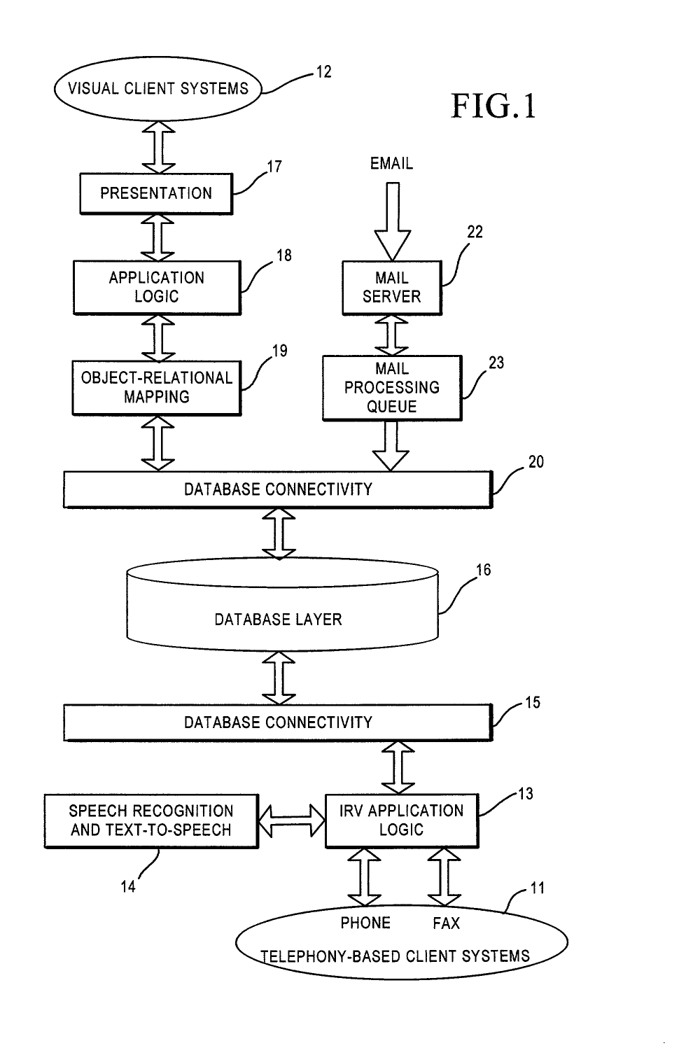

FIG. 1 shows a high level view of the overall system of the present invention. The system can be entered via the conventional public telephone system shown generally at 11, either by telephone call or facsimile, or through a public network such as the internet, shown generally at 12. Telephone and facsimile communications with the system (in both directions) are accomplished through an interactive voice response (IVR) logic portion 13 which can work with associated speech recognition and text-to-speech applications 14. Application logic 13 interfaces through a connection application 15 to a single data base 16 which contains all of the record/file information in the system.

Network communication requires a presentation device (layer) such as a PC or palm-held device 17, working through an application logic portion 18 and then through a relational mapping application section 19 and then through a connection interface 20 to the database 16.

E-mail communication proceeds with an E-mail server 22 and a mail processing queue application 23, through connection interface 20 to database 16.

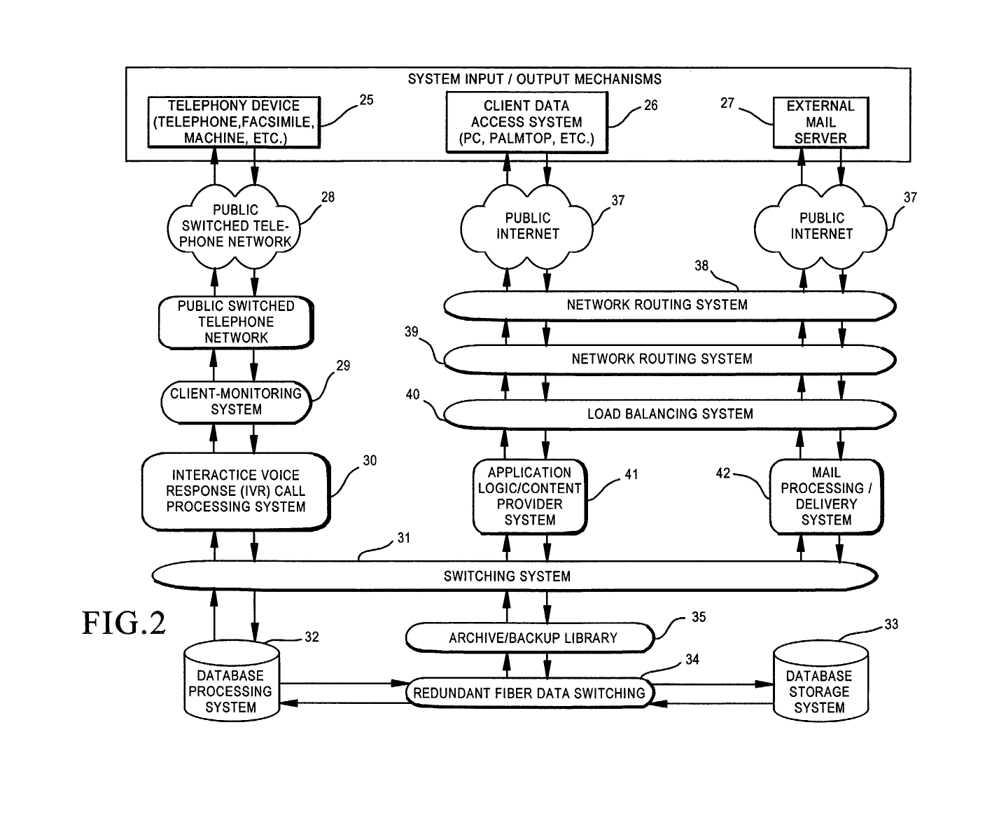

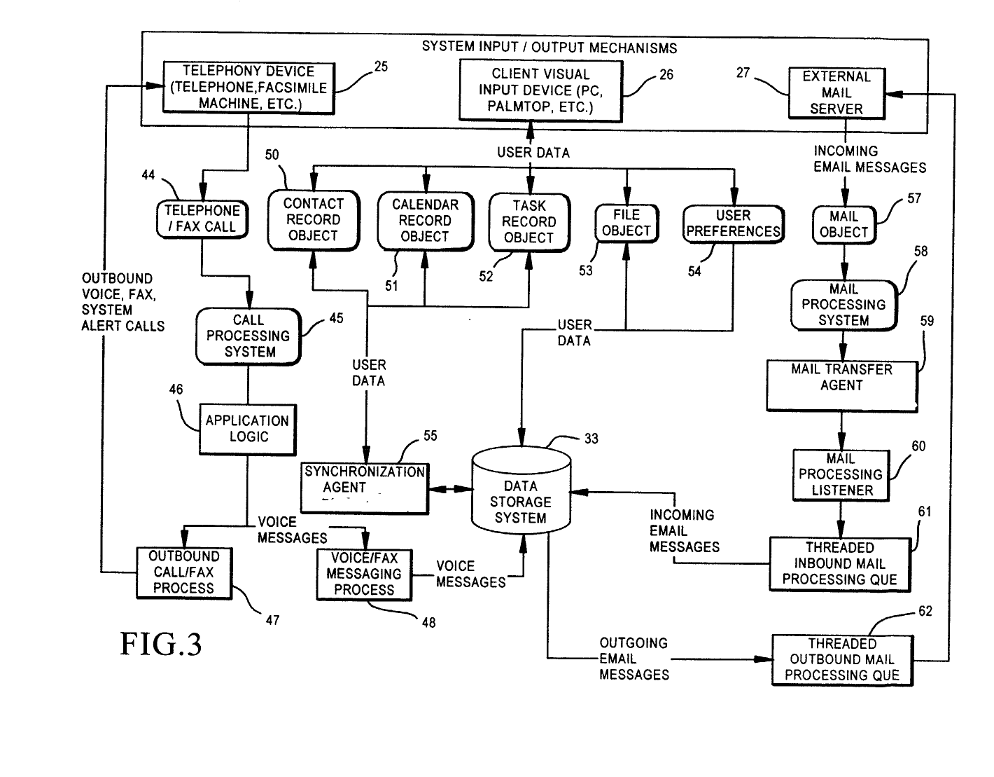

FIG. 2 shows a more comprehensive diagram of the overall structure of the system of the present invention, while FIG. 3 shows the data flow. Referring to the structure diagram of FIG. 2, various devices comprise the input/output devices for the system, both for users within the communication system per se and for those who are attempting to contact individual users within a user organization operating with the system of the present invention. The devices may be telephony-type devices 25, such as a telephone or facsimile machine or network access devices (visual) 26, such as a PC, laptop, palm-type device, or an E-mail server 27.

The telephony devices communicate through the public telephone network 28 and a client monitoring portion 29, to an interactive voice response call processing system 30. Communication is established with the system through a switching system 31 to a database processing system 32, which is in turn connected to the single database storage system 33 through a fiber data switching device 34. Between switching system 31 and fiber data switching device 34 can be positioned an archival backup system 35 which can be used for archival storage of information separate from the system database storage system 33. This is not necessary, however, for the system of the present invention.

The network access devices 26 and the E-mail server 27 are both connected by means of the public internet 37 through a network routing system 38 within the present invention, as well as a switching system 39 and a load balancing system 40. The network devices are connected through an application system 40 to the switching network system 41, while the E-mail server portion is connected through a mail processing delivery application 42 to the switching system. As discussed above, the switching system connects to the processor and the database.

FIG. 3 shows the overall flow of data within the system of the present invention. The telephone devices 25 provide the basis for a telephone or facsimile contact shown at 44, which is then applied to a call processing system 45, with voice command capability via the IVR system to application logic 46, which then controls the desired outbound call or facsimile process 47 or the voice and facsimile messaging process 48. The received voice messages are stored in the data storage system 33, while the outbound calls or facsimiles are sent out through the telephone devices 25.

Calendar information data for the individual users can be viewed through the network visual devices. This information includes contact records 50, calendar records 51, task records 52, files 53 and user preferences 54. The contact records, calendar records and task records are applied through a synchronization application 55 to the data storage system 33, while the files and user preferences are applied directly to the data storage system 33.

The external E-mail server 27 processes incoming E-mail messages, through a mail object application 57, a mail processing application 58, a mail transfer agent 59 and a mail processing listener 60. The E-mail is then put through a processing queue 61 and stored in the storage system 33. Outgoing E-mail messages are put through the outbound processing queue 62 and back to the E-mail server 27 for transmission.

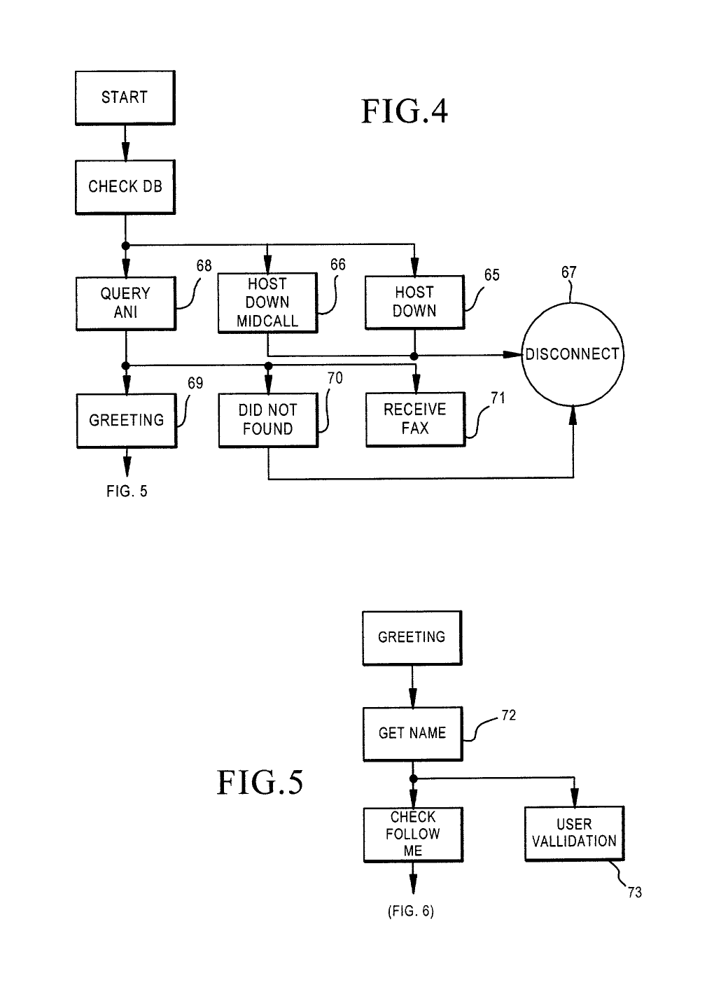

FIGS. 4-34 include the telephone system portion of the system of the present invention, with interactive voice response (IVR). It includes a sequence of functions and applications to receive and direct incoming voice calls, provide for, substantiate and carry out outgoing voice calls and to maintain an account of each individual user's activity within the user organization. Each individual user within a user organization has their own telephone number in the system and an integrated (unified) incoming and outgoing messaging capability. The telephone (voice response) portion, which communicates with the network (internet) portion (which is discussed below) via a single database, accomplishes the directing of incoming calls by an IVR (interactive voice response) capability and/or queries which are formulated based on information in the system database about the calling party.

FIG. 4 shows a first part of the main menu section of the voice response portion flowchart. An incoming phone call to the voice portion of the present invention, which will typically be the phone number of an individual known to the system, such as another individual user in the user organization, initiates the operation of the voice response (telephone) portion.

When a call is received, the number of the user in the organization being called (the number sometimes referred to hereinafter as the DID) and the number of the calling party (referred to as caller ID or automatic number identifier (ANI), are provided to the system database; while the telephone portion of the system can in fact operate without the ANI number, the DID number is necessary. The system database is checked first to verify that the database connection is in fact operating. An indication is provided at the beginning of the call (block 65) or at any point in the call (block 66) if the database connectivity fails for any reason. If there is a difficulty, the incoming telephone call is disconnected (block 67), after delivery of a warning message to the calling party. If the database and the connection are in order and working appropriately, the database will be queried for any information concerning the calling party (ANI, block 68), and a system greeting to the calling party will occur, as shown at block 69. The system processor checks the database to see whether the called number (DID) is within the database (block 70); if not, a warning is provided to the calling party and a disconnect occurs.

Upon the caller's initial connection with the system, the system will check the information and preferences of the individual user in the database with the DID (the called number). The system also at this time listens for FAX tones on the line so that if the calling party is sending a FAX message (instead of a voice call), a “receive FAX” process may be initiated, if the tones are recognized; if so, the FAX is then received by the system, as shown at block 71.

FIG. 5 shows the entry into the system by an individual user, typically to check their messages and to reply, if the user desires. After the greeting, the system identifies the user (by name) attempting to log onto the system (block 72). Typically, this attempt by an individual user to enter the system to retrieve his/her messages is achieved by either a spoken phrase which is recognized by the system, e.g. “it's me”, or by the user pressing a selected key on a touch-tone phone. If an individual user's attempt to access the system is recognized, there follows a user validation procedure prior to the user gaining access to the system. This function is shown at block 73 and is discussed below.

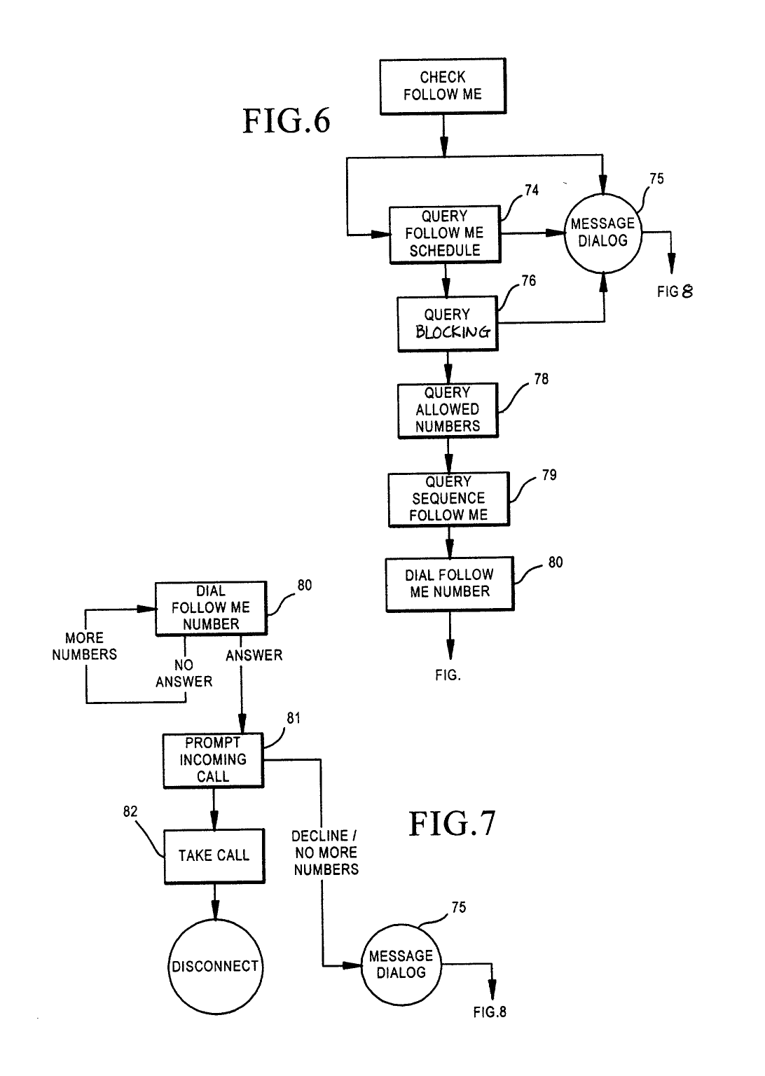

If an attempt to access the system for messages is not recognized, the system understands that the incoming call is to a user within the system and will prompt the calling party to record their name; the system then attempts to reach the called party at the called party's stored additional numbers in the database. This is referred to as the “follow me” procedure within the system. The “follow me” procedure is shown in FIG. 6. The “follow me” procedure can be set to inactive, at which point the system will go to a message dialog procedure (which is discussed in more detail below). If the “follow me” procedure is active, the particular schedule of the called party (stored in the database) is checked (block 74) to determine the times during which incoming calls may be routed to the called party. Otherwise, they will go to the message dialog (voice mail) system (block 75).

At block 76, a check is made to see whether any blocking features to prevent further processing of the incoming call are in place. This could include blocking of selected incoming numbers or caller individuals. If the incoming call is to be blocked, the call is passed to the voice message portion. In the next block (78), the system finds from the database the particular telephone numbers which have been previously indicated by the user as locations where he/she may be reached for a direct call. When those telephone numbers have been identified, they are listed in a particular sequence (block 79) and are then called in that sequence by the system, as shown at block 80.

The specified calling sequence of individual numbers is followed by the system. In the present embodiment, a total of six different numbers in a selected sequence are possible. However, it should be understood that fewer or more numbers may be used in a sequence. The first number in the sequence is dialed by the system. If there is no answer to the first number, after a selected number of rings, the other numbers in the sequence are dialed, in the designated order.

If no answer is received after all the numbers in the sequence have all been exhausted, the incoming call will be directed toward the message dialog (voice messaging) component of the system.

An answer (if any) to the incoming call is evaluated by the system, first to determine whether there are any error tones or other non-human responses in the answer. If there is a human response, the system prompts the called individual user (block 81 in FIG. 7) concerning accepting/declining the incoming call, which prompt will include playback of the calling party's recorded name, prior to connecting the called party with the calling party. In accepting (taking) the incoming call (block 82), the individual user may use voice or touch-tone commands, at which point a live telephone connection is made to the calling party; the basic communication system now becomes quiescent. The connected call continues until there is a disconnect. If the individual user declines to accept the incoming call, the calling party is directed to voice messaging, (block 75).

Hence, an incoming telephone call proceeds through a sequence of telephone numbers (referred to as the “follow me” process), the sequence and times of which are determined by the user and stored in the database. The caller will be forwarded to voice mail if the called party either does not respond, or responds and declines to take the call. If, on the other hand, the called party responds and accepts the call, a telephone connection is made between the calling party and the called party, which continues until there is a disconnection by one of the parties. A log of both the incoming and outgoing calls is made in the database relative to the individual user.

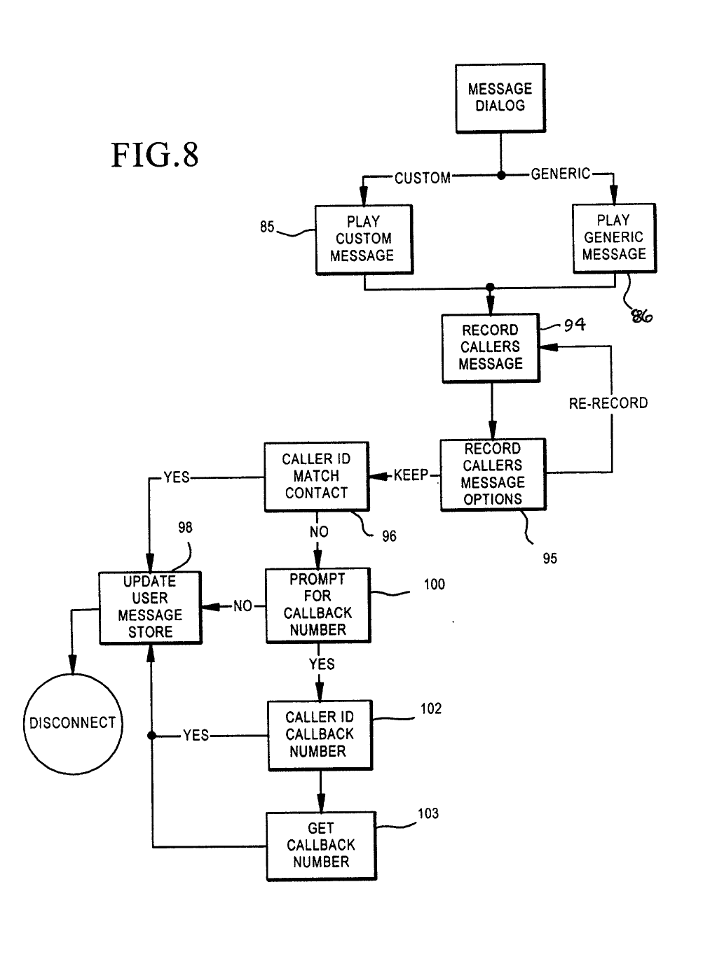

In the voice messaging component (FIG. 8), the system will record a voice message left by the calling party. Before that occurs, however, a voice mail prompt, either a custom, user-recorded prompt (block 85) or a generic, pre-recorded conventional prompt (block 86) is played for the calling party. The system records the calling party's message, shown at block 94. The system then provides a number of message options (block 95) to the calling party. One possibility is a re-recording of the message by the caller.

The system will then attempt to find a match of the calling party's ANI with the entries in the called user's address book (in the database), as shown at block 96. If there is a match, a pointer is set to the contact record in the database with the recorded message. This is shown at block 98, prior to disconnect.

If the calling party is not in the called user's address book, the system prompts the calling party to leave a call-back number, as shown at block 100. If a call-back number is not left by the calling party, the system defaults to recording the calling party's ANI, with the message, and then disconnects. If a call-back number is left, then that number is used in association with the caller's message (block 102) and that number is then stored (block 103).

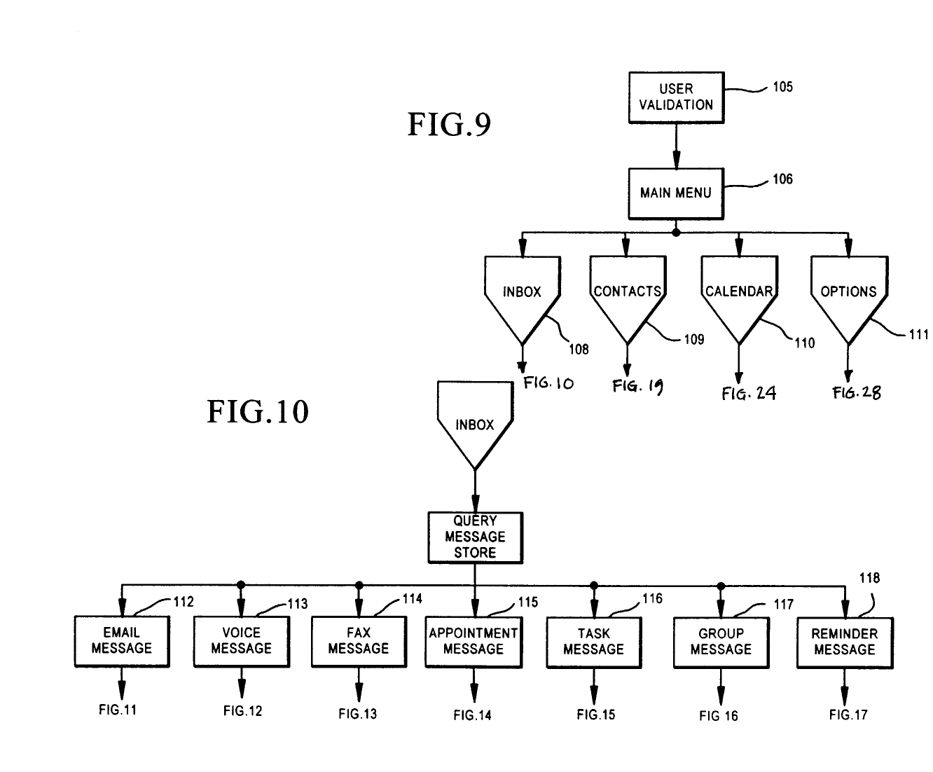

As indicated briefly above, referring now to FIG. 9, a user validation sequence (block 105) is initiated when a user is attempting to obtain messages from the system, after the system detects the voice phrase “it's me” or other preselected phrase, or by identifying a particular individual user in the system through voice recognition, or by the detection of operation of a selected key on the phone pad, at the beginning of the call. The individual user in the validation sequence will enter a password unique to him/her, either by speaking the password or entering the password value by the touch-tone phone (DTMF—dual tone, multi-frequency). Once the validation procedure is successful, the individual user then, through the main menu (block 106) is free to identify various message locations in the system identified with him/her.

At the main menu (block 106), the possibilities offered in the embodiment shown are inbox-messages (block 108), contacts (block 109), calendar information (block 110) and system options (preferences) (block 111). Each of these will be discussed in turn. FIG. 10 shows the inbox (message) possibilities for the system of the present invention (blocks 112-118). Upon selecting any of the inbox possibilities, the user is presented with the number (count) for each of the various message types, including, in the embodiment shown, messages which are differentiated between new and previously reviewed entries.

The present system allows users to select the types (modes) of messages to be reviewed in any order. In regard to the various modes of messages possible, the present system allows use of conventional electronic messaging systems, where available, for communicating with other parties. For instance, E-mail messages from another party may produce a reply through a conventional/existing E-mail system of the user organization, such existing E-mail system having been integrated into the system of the present invention.

It should initially be noted that in the present system, certain messages in the database, notably E-mail messages, voice messages and FAX messages, permit a detailed substantive reply, while other messages, involving which is generally referred to as calendar or schedule information, such as appointment messages, task and group messages, permit only an acceptance or decline in reply. This is discussed in more detail below.

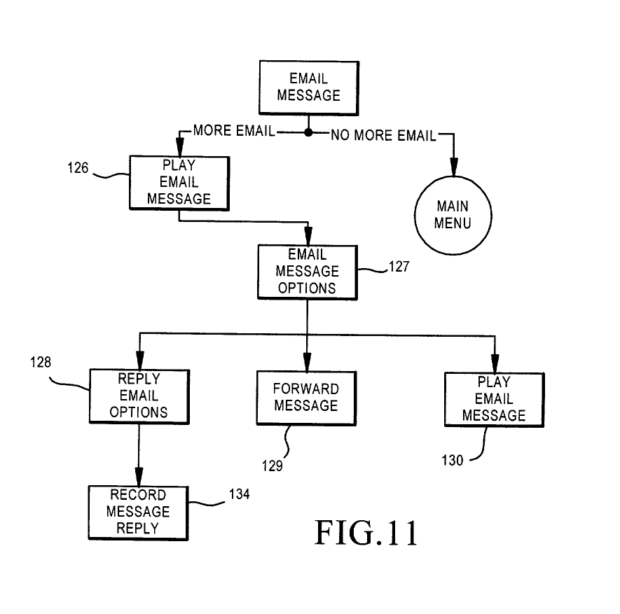

E-mail messages, which come into the system to one or more E-mail addresses belonging to the individual user in the user organization, are presented in sequence to the user for review, with the most recent messages first, followed by those E-mail messages which have previously been saved, as shown in block 126 in FIG. 11. On the other hand, if there are no E-mail messages for the individual user, the individual is directed back to the main system menu, or the inbox portion thereof (FIG. 10) for selection of other messages. With respect to each E-mail message present, the individual user has several options, as indicated at block 127. Using conventional text-to-speech applications, the user listens to the E-mail messages. The user then has several specific options, which include: (1) sending a reply to the sender, or all recipients, of the original E-mail message, as shown in block 128; (2) forwarding the E-mail message to another E-mail address or to a FAX machine, as shown in block 129; or (3) replaying/deleting the message, as shown at block 130. If there is to be a reply to the E-mail, the reply message is recorded, as indicated at block 134, and the voice data is attached to the reply message.

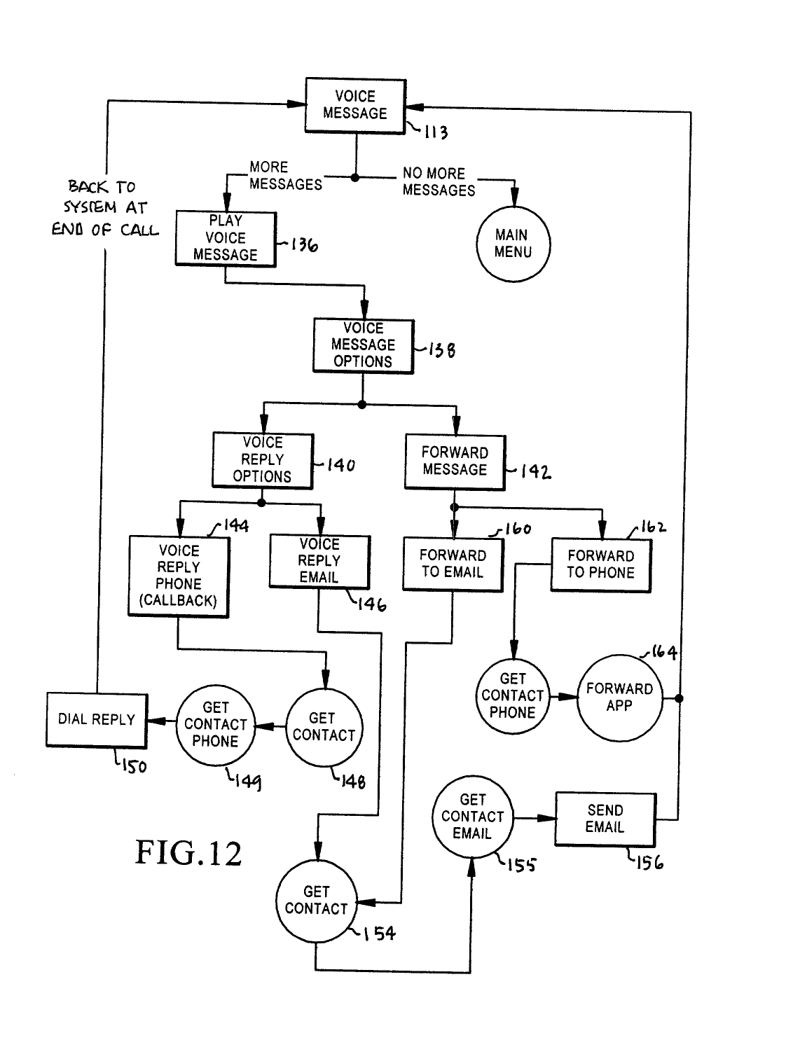

The voice messaging procedure is shown in FIG. 12. When requested by the user, the voice messages are played in sequence as stored, similar to that for E-mails, as shown at block 136. If there are no voice messages, then the user is returned to the main menu or the inbox (message) portion thereof. If there are voice messages, the individual user is provided at the end of each message with the voice message options, as shown in block 138. These include various reply options (block 140) or forwarding options, as shown at block 142.

In the voice reply options, the individual has an opportunity to reply via telephone (an outbound call), referred to as a callback, at block 144, or an E-mail reply, at block 146. The callback number will be obtained from the individual user's address book (the caller ID) or as provided by the calling party during the obtaining of the original message. The individual user also has the opportunity to locate the entry information for the calling party by means of the “contacts” portion of the system , as described below. In the present system, the calling party is thus identified as a “contact”, one of the possible phone numbers for the contact is selected, and then a reply call is dialed by the system. These functions are shown in blocks 148-150.

If the reply is to be by E-mail, the same procedure is followed, i.e. the contact is identified, the E-mail addresses of the contact are provided by the system, and the E-mail is sent, with the individual user's recorded reply being attached to the E-mail and delivered to the selected E-mail address. This process is shown in blocks 154-156.

If the voice message is to be forwarded, as shown at block 142, it may be forwarded to an E-mail address, as shown at block 160, or to a phone number, as shown at block 162. The procedure for obtaining the E-mail contact address and forwarding the E-mail (blocks 154-156) is the same as for the voice E-mail reply option, while forwarding to a phone number requires obtaining the appropriate number from the user's address book or obtaining another phone number which may not be contained in the address book. The message is then forwarded by a forwarding procedure (application), which is described in more detail below, as shown by block 164.

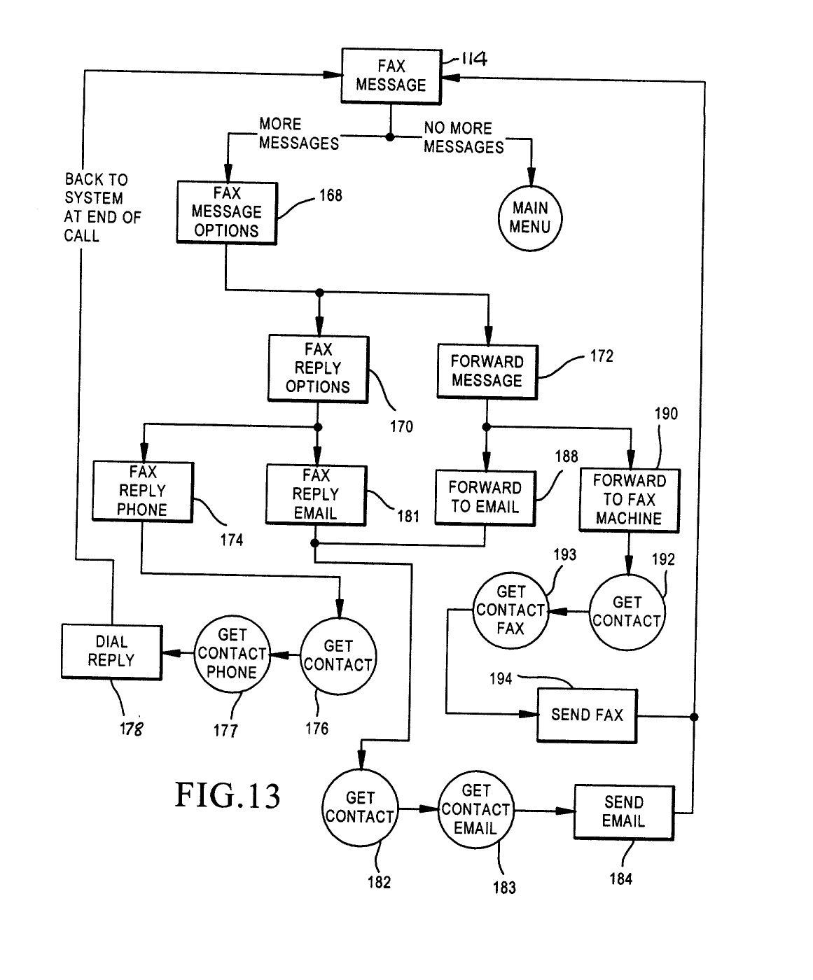

The review and reply/forwarding process for FAX messages received by the present system for the individual user is shown in FIG. 13 and is similar in general to the E-mail and voice messaging processes, although it is described herein for purposes of completeness. First, the FAX message information (source FAX number, data, time, etc.) is presented to the user in the order the messages are received for review . The FAX message options (block 168) are then presented to the user, which include a reply to the FAX, shown at block 170, or a forwarding of the FAX, at block 172. Under the reply options, the user can reply by phone, at block 174, which requires obtaining the name and phone number of the contact. If the name of the contact is in the user's address book, then the sending FAX number may be in the address book as well, correlated to the contact. If there is no record of the sending FAX number in the address book, the user may utilize the “contacts” process described below to locate the receiving party. The available phone number is then obtained and the phone number is dialed by the system. This sequence is shown at blocks 176-178. At the end of the process of reviewing/delivering/forwarding FAX messages, the user is returned to the main menu or the inbox portion thereof.

Another reply option to a FAX is through E-mail, as shown at block 181. In the reply E-mail mode, the person (contact) who is to receive the reply E-mail is identified from the user's address book or through the contacts process. The E-mail address of that person is then obtained and the E-mail sent, as shown at blocks 182-184.

With respect to the forwarding option for FAX messages, shown at block 172, the message may be forwarded to an E-mail address, as shown in block 188 and blocks 182-184; or in another option, the message may be forwarded to a FAX machine, as shown at block 190. In the FAX machine forwarding option, the identity of the contact is first obtained, the FAX number is obtained from the user's address book, and the FAX is then forwarded to that FAX number, as shown in blocks 192-194.

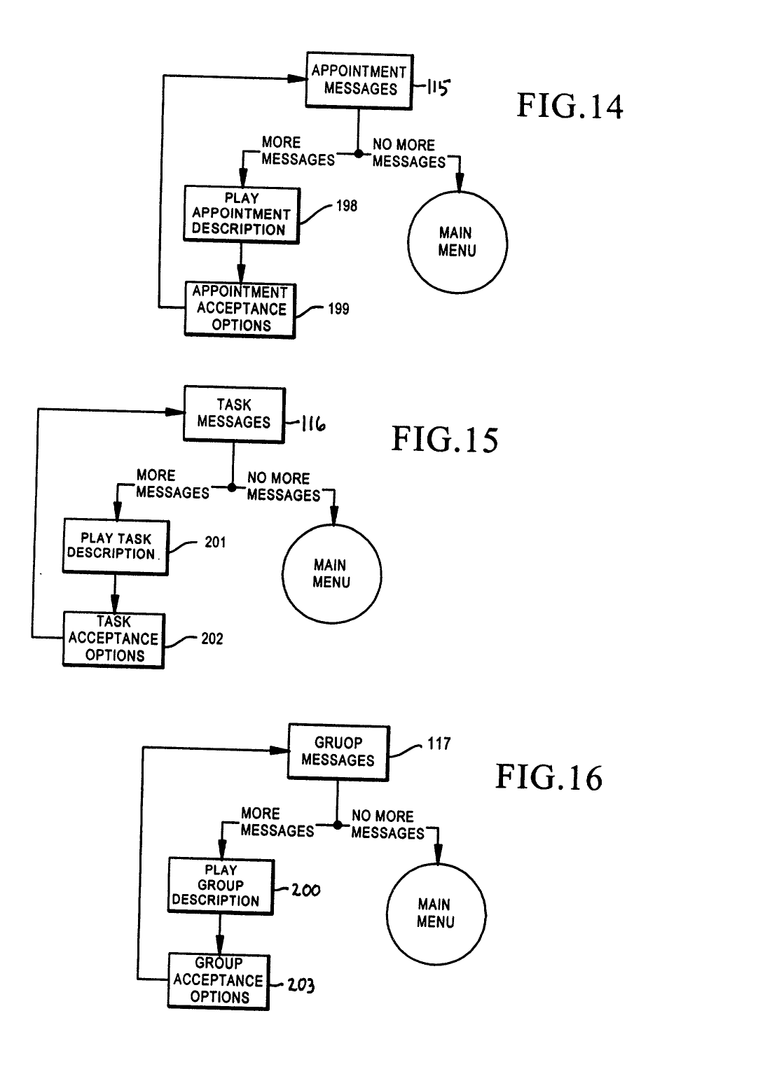

Returning again to FIG. 10, the user has any appointment messages (block 115) from within the user organization which are stored for him/her in the database. Referring to FIG. 14, the system permits the individual user to play the appointments, as shown at block 198, and to either accept or decline them. The appointments are offered by other individual users within the user organization. In the embodiment shown, appointments which are accepted by individual users to whom they are offered will appear automatically in the user's calendar within the system (also stored in the database). This is done by an E-mail message. Appointments which are accepted or declined will result in an E-mail message being sent back to the individual who offered the invitation, as shown at block 199. When there are no more appointment messages to be heard, the user is returned to the main menu or the inbox portion (FIG. 10).

FIG. 15 shows the task message portion of the system. The task message retrieval system permits individual users to play each of the task descriptions to which they have been assigned by another individual user in the user organization (block 201) The user may then accept or decline the task offered. Tasks which have been accepted will appear in the user's task list in the database, related to the user by name. Tasks which are accepted or declined by the individual user will result in an E-mail message being sent back to the user who initiated the task assignment, as shown at block 202. The task messages can be reviewed until there are no more such messages; the individual user is then returned to the main menu or the inbox portion of the system.

FIG. 16 shows the group message portion of the message system, i.e. messages in the database associated with the individual user, where the user has been asked to participate in a group. The group message retrieval process permits individual users to hear the name of the group and the group administrator who invited them for all invitations to participate in groups within the user organization (block 200). Those group invitations which are accepted by the user will then appear as one of the choices for sharing or viewing stored data within the database, as well as allowing access to the “group calendar” part of the system. Group invitations which have been accepted or declined will result in an E-mail message being sent back to the individual user who sent the invitation (block 203). When all the group messages have been heard, the user is returned to the main menu or the inbox portion of the system.

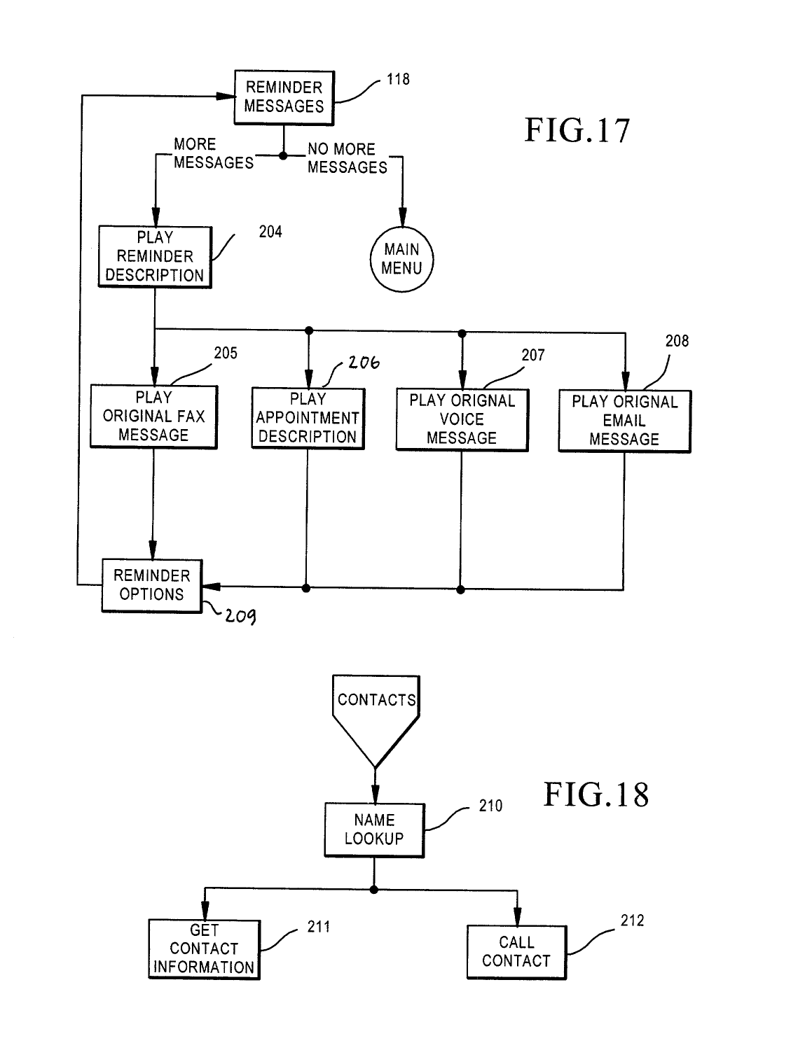

Reminder messages from the portion of the system are shown in FIG. 17. The reminder messages can be played only by individual users. The reminder messages are created by an individual user as a result of an earlier message in the system to remind the individual user of important dates, tasks, etc. The user may review the subject and description of the reminder (block 204), as well as hear the original FAX message (block 205), voice message (block 207) or E-mail message (block 208) which was the impetus for the reminder, as well as a description of any appointments (block 206). The user has the option (block 209) of deleting the reminders. The original messages, however, cannot be deleted in this portion of the system.

Referring now back to the main menu (FIG. 9), another major portion of the system of the present invention concerns what is referred to as contact information. Contact information is used in various portions of the system to provide the user information for responding to particular messages or to call a contact. Contact information may be stored with other users in the database system. This portion of the system is set forth in FIGS. 18-23.

FIG. 18 shows the initial part of the contact portion of the present system. The user can get to the contact portion of the system in the database from either the main menu (FIG. 9) or from any other part of the system that requires a contact record, such as the constructing of replies to various messages or the forwarding of various messages. Initially, the contact process requires the lookup of a name, as shown in block 210. In the present embodiment, the lookup process for the contact name can be initiated by speech or by DTMF, including spelling of the person's last name or by simply saying the person's name. Once the name lookup has been achieved, the user may request additional information (block 211), or may initiate a call (block 212) to the named individual, based on the number associated with that contract.

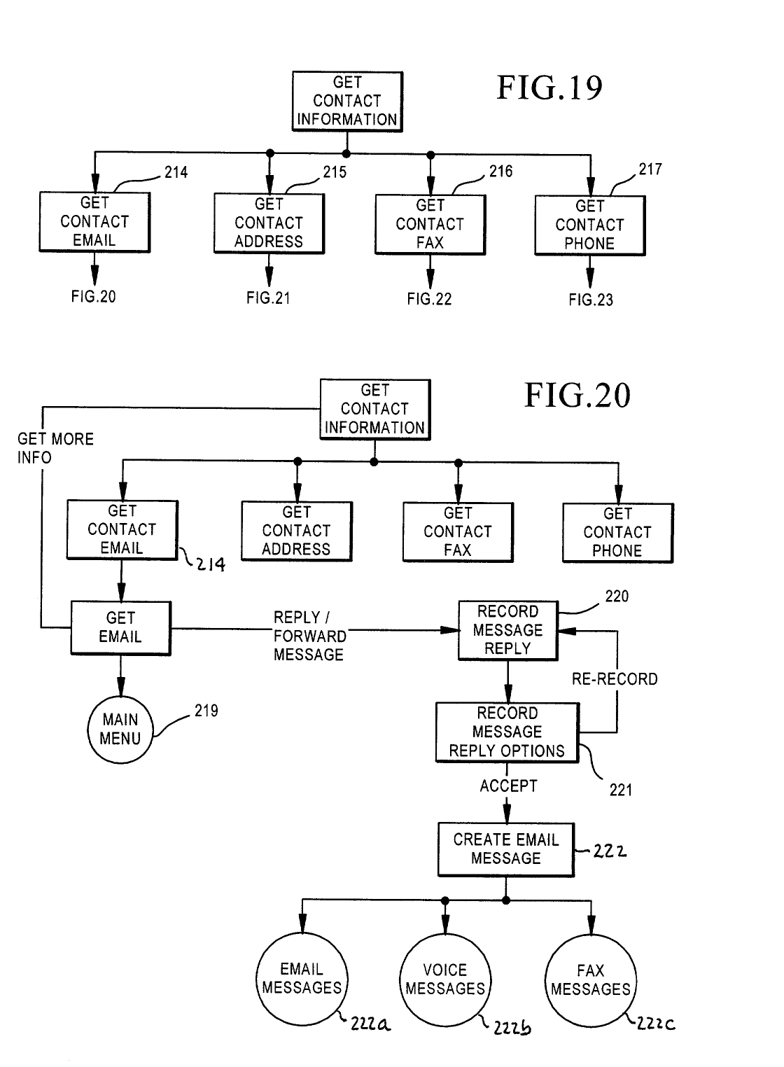

FIGS. 19-23 show more detail on contact information. Referring to FIG. 19, once the contact name is known, the individual user has a choice as to what information to request, including an E-mail address (block 214), a postal address (block 215), a FAX number (block 216) or a phone number (block 217). All of this information is stored in the database associated with the named contact.

FIG. 20 shows the E-mail contact process. If the purpose of obtaining the E-mail address for the contact is simply to get the information, then, upon retrieval of the E-mail address, which is delivered to the user via a conventional text-to-speech process, the user will be returned to the contact routine and provided an opportunity to obtain additional information about the contact name which is in the database. The user also has the opportunity to return to the main menu or the inbox portion of the system. This is shown in block 219. The individual user also has the opportunity to reply or forward an E-mail message to the named contact directly upon obtaining the E-mail address. The user can record an audio message and then review/re-record the message, as message reply options, as shown in blocks 220 and 221. After the recorded message is “approved” by the user, the E-mail message is created (block 222) and transmitted, as an E-mail or by telephone (222a-222b) It is anticipated that a FAX message would also be possible(222c). The user is then looped back to obtain more contact information or to the main menu.

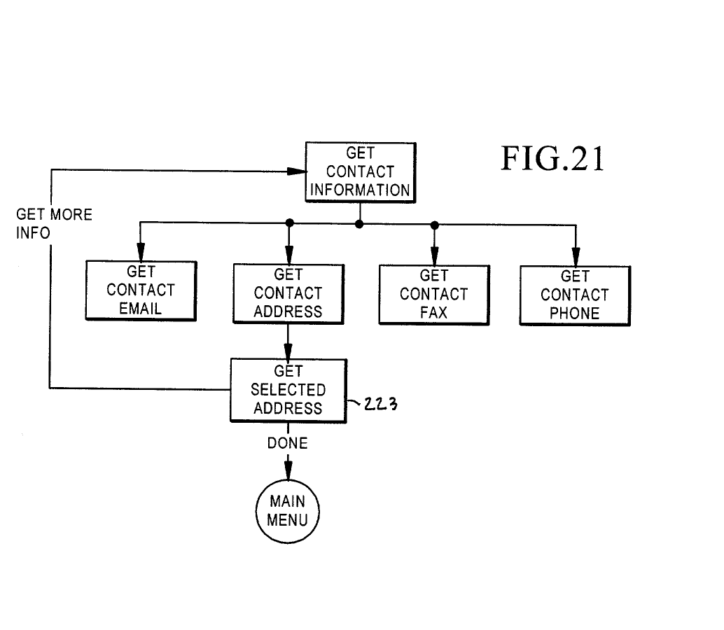

In FIG. 21, the user has the opportunity to obtain further information from the database, namely the postal address(es) of the contact, as shown in block 223. The user is then returned to the main menu or the inbox or given an opportunity to obtain more contact information.

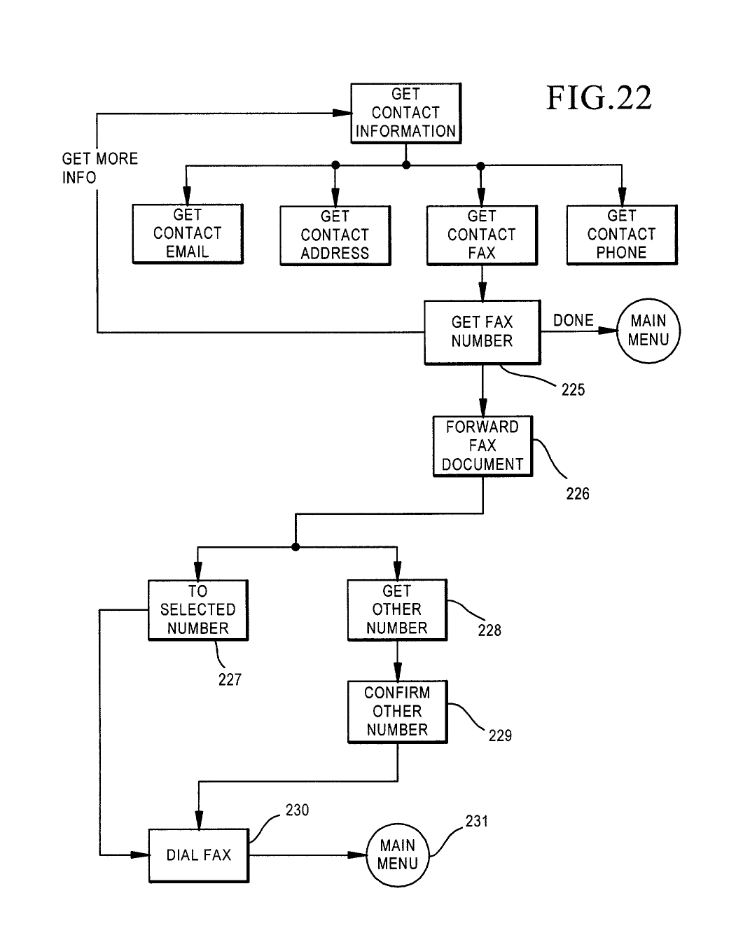

In FIG. 22, the FAX number of the contact can be obtained, at block 225, after which more contact-related information can be obtained, or the user returned to the main menu. In typical operation, once the FAX number is obtained, the user can forward (block 226) a FAX document to the selected number obtained (block 227), or to a different number for that contact(block 228), after that number has been confirmed (block 229), using either speech recognition or DTMF tones. The FAX number is dialed by the system and the document FAXed to that number, as shown at blocks 230 and 231.

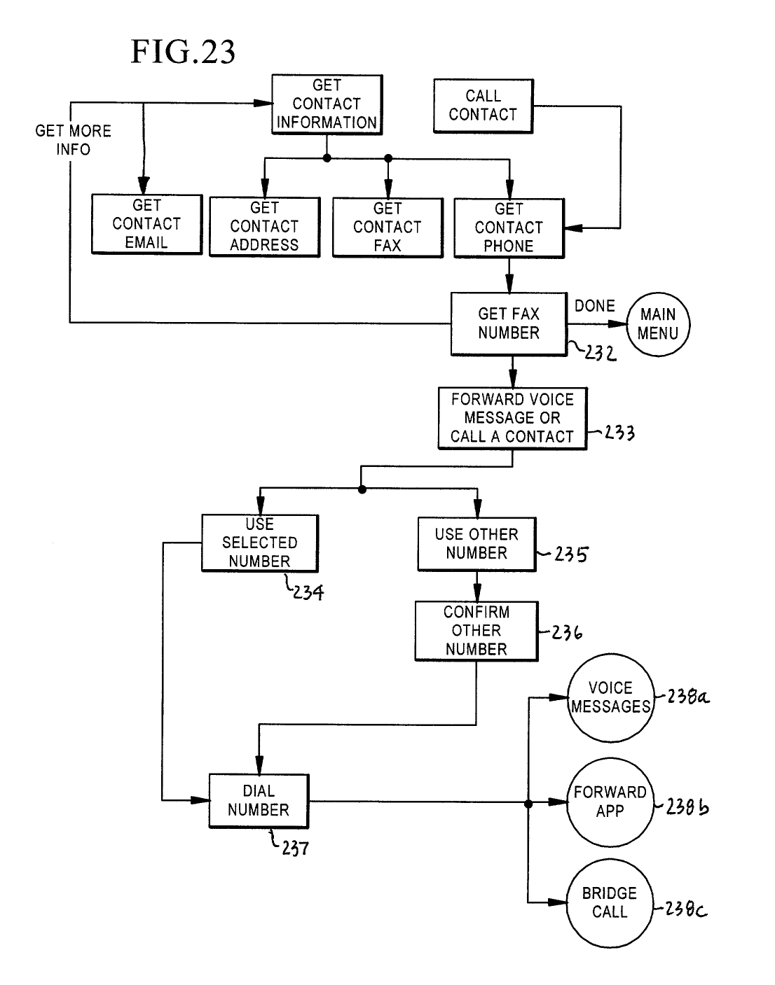

FIG. 23 shows the process for obtaining the phone number for the contact name. The phone number can be obtained for information only (block 232), with the user being returned for more information about the contact, if desired, or can returned to the main menu. In typical operation, when the phone number has been obtained, a voice message can be forwarded to that number (block 233) or an out-bound call to the contact can be made, using the selected contact number obtained (block 234) or another number(block 235), using either speech recognition or DTMF tones. If another number is to be used, that number is confirmed (block 236), and then the selected number (the looked-up number or “other” number) is then dialed by the system (block 237). The out-bound call can result in a voice message, the initiation of a forwarding procedure (explained below) or a connected call which may be “bridged” by the system, in the sense that users are returned to the call flow control portion of the system after the call is completed (blocks 238a-238c).

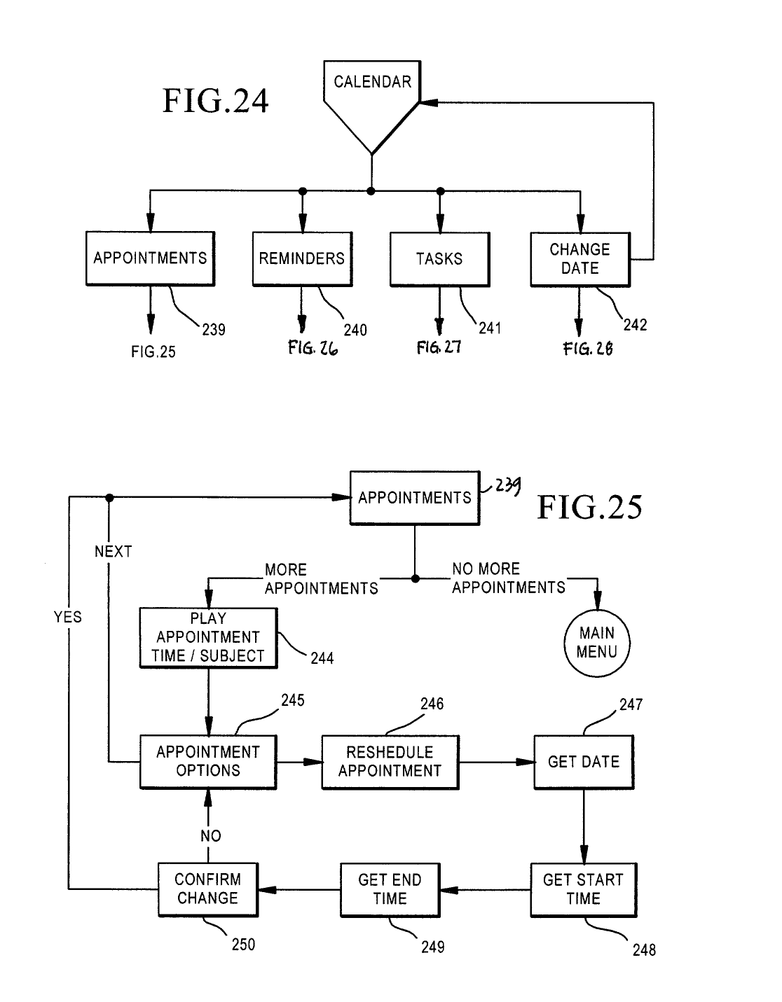

Another major part of the communication system is the calendar, which is shown generally in FIG. 24. Individual users in the system may access the calendar module from the main menu or from any part of the call flow system which references calendar information. Individual users, for instance, who receive and accept appointment invitations, as described above, will have immediate access at that point in the system to the data in their calendar. Calendar data starts with the current date and time, as determined by the user's time zone settings which is part of their stored preferences in the database. The calendar includes sections dealing with appointments, reminders, tasks and date control. These are shown in the following figures and referred to generally at blocks 239-242 in FIG. 24.

FIG. 25 shows the process for reviewing appointments in the calendar module from the IVR (telephone) portion of the system. When reviewing appointments for a particular day, users will hear the start and end times of the appointments and a description of the subject matter of the appointment, as shown at block 244. For each appointment entry, the individual user then has several options (block 245). The user may reschedule the appointment, as shown at block 246, or proceed to hearing the next appointment. If the user reschedules, the user speaks the new date, the new start time and the new end time, at blocks 247-249. The change is confirmed at block 250. Any participants are notified of the change through the inbox module, and the user is then returned to the start of the appointment routine to review the next appointment record. If changes are not confirmed, the user has an opportunity to hear the appointment options again.

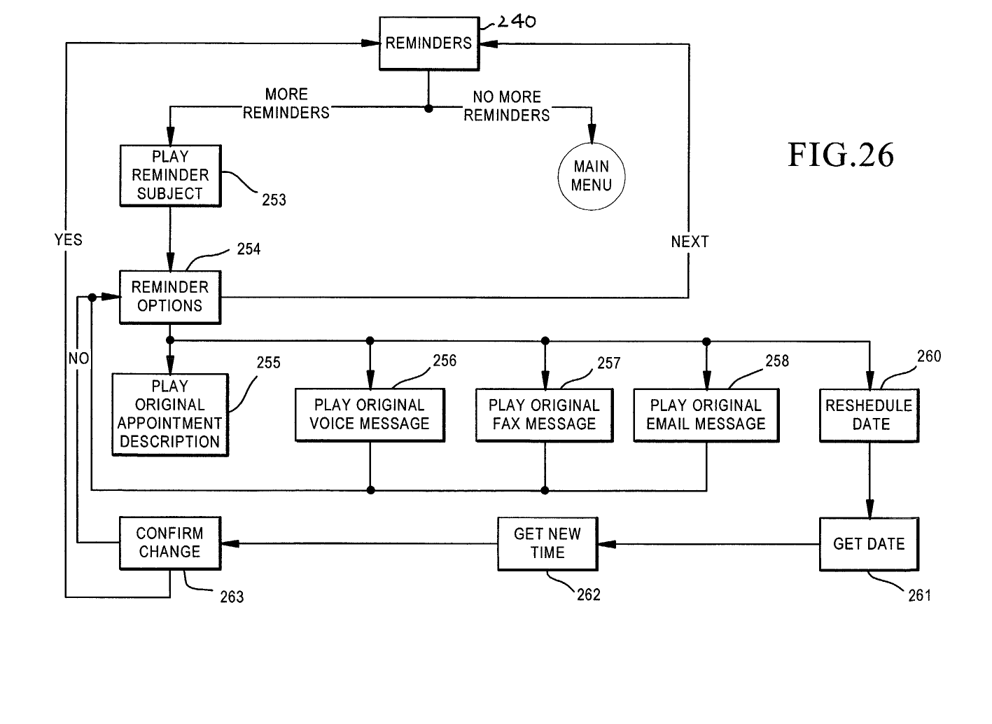

The reminder part of the calendar portion of the system is shown in FIG. 26. In the reminder part, the user has access to the individual reminders, as shown at block 253. After hearing the reminder subjects, the user then has several options, at block 254, which include hearing the reminder description or reviewing the original voice message, FAX message or E-mail message, as indicated at blocks 255-258. The individual user in the embodiment shown has the option of hearing the original message at various times, provided that the original message has not been deleted from the system. Deletion of the original message will not automatically delete the reminders. The user may also elect to review the next reminder without replaying any of the original messages.

A reminder may also be rescheduled through the calendar portion of the system, as shown at block 260. If the reminder is rescheduled, a new date and time are obtained, with the change being then confirmed, at blocks 261-263. If the change is confirmed, then the user is returned to the start of the reminder portion of the calendar. If the change is not confirmed, then the user is returned to the start of the reminder sequence to review the next reminder.

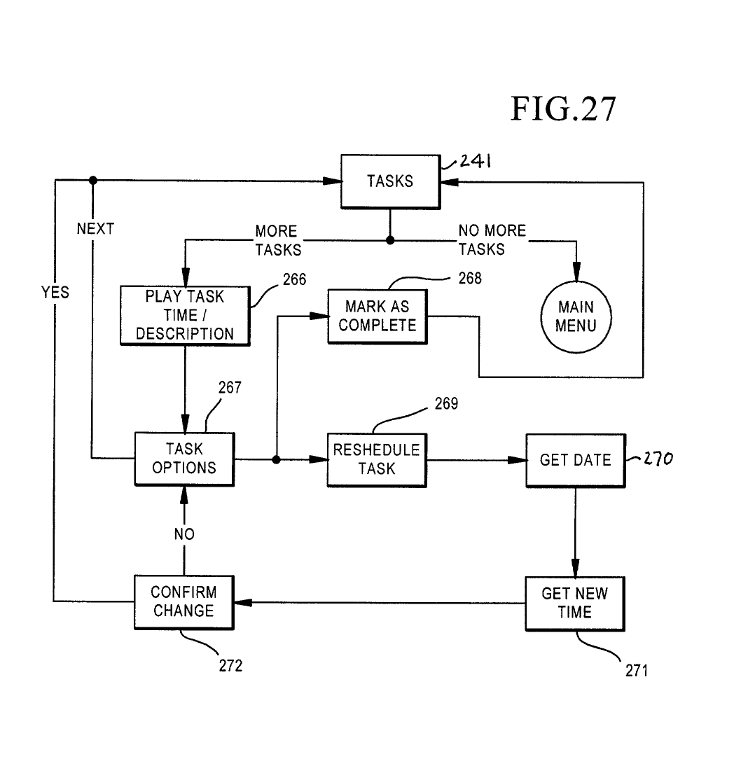

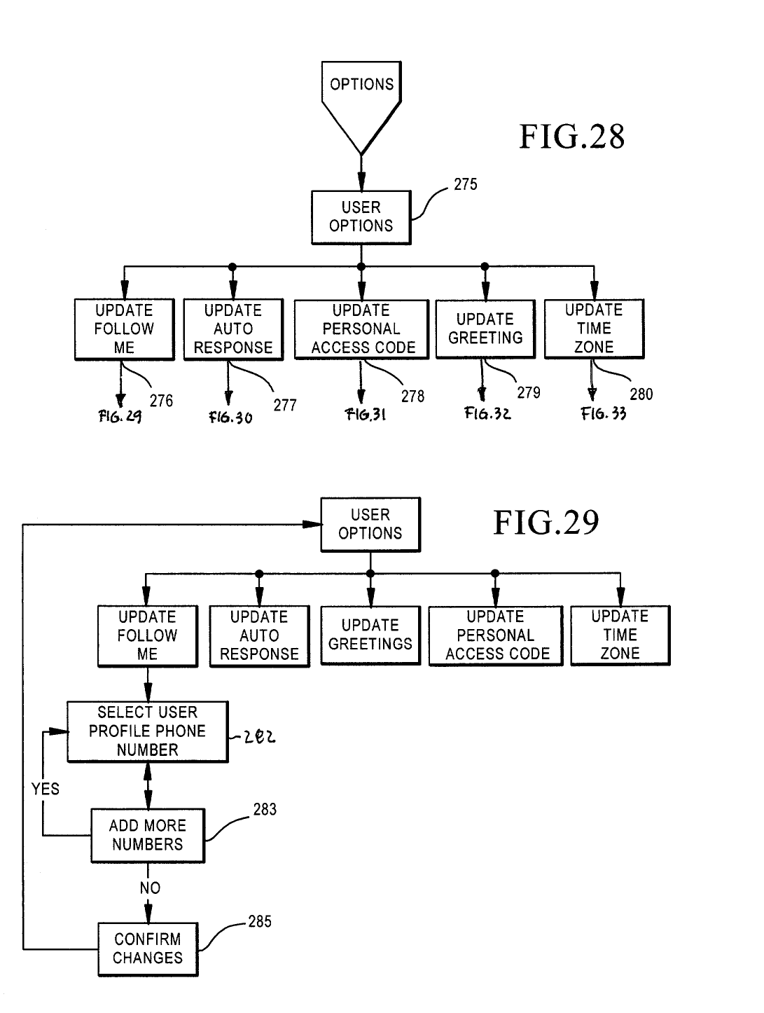

FIG. 27 shows the task part of the calendar portion. The tasks set forth in the calendar are first heard with respect to their scheduled completion time and description, as shown at block 266. The user is then presented with task options, one of which is to indicate that the task has been completed, as shown at block 268. If the task is completed, an E-mail is sent to the individual within the user organization who is responsible for the task being completed and who originally assigned the task to the user. The user is then returned to the start of the task review process of the calendar. The user also has the option to proceed to the next recorded task, or to reschedule the present task, as shown at block 269. If the task due date is to be rescheduled, which can only be done by the initiator of the task, the user provides a new date and a new time (through speech or DTMF) and confirms the change, at blocks 270-272. All of the task assignees are then notified of the changes. If the user does not confirm the time, the user is presented with the task options prompt again; if the change is confirmed, the user is returned to the start of the task portion to review the next task in the sequence.

The next portion of the main menu in the telephone portion of the system concerns “options” (FIG. 28) which are available to the individual user. As shown in block 275 in the options portion, the user is initially presented with the various user options. These include updating the “follow me” call procedure (block 276), the enabling/disabling of the automatic response message for incoming E-mail messages (block 277), updating/changing the personal access code (block 278), changing the customized greeting(s) provided to callers (block 279), and an update/change in time zone location of the user (block 280), as determined by the time zone portion. The time zone location portion of the system is important, in that it enables the system to mark the date/time and to accurately process scheduled alert messages for all date/time sensitive material.

In FIG. 29, the individual user can configure the “follow me” settings as desired. The user can select, in the embodiment shown, up to six different numbers to be dialed by the system in a particular sequence. The user selects from numbers which are currently stored in the user portion of the database or from temporary numbers as specified by the user (block 282). Numbers may be added to the schedule, as shown in block 283. If the changes are confirmed, then the user is directed to the start of the user options portion, as shown in block 285.

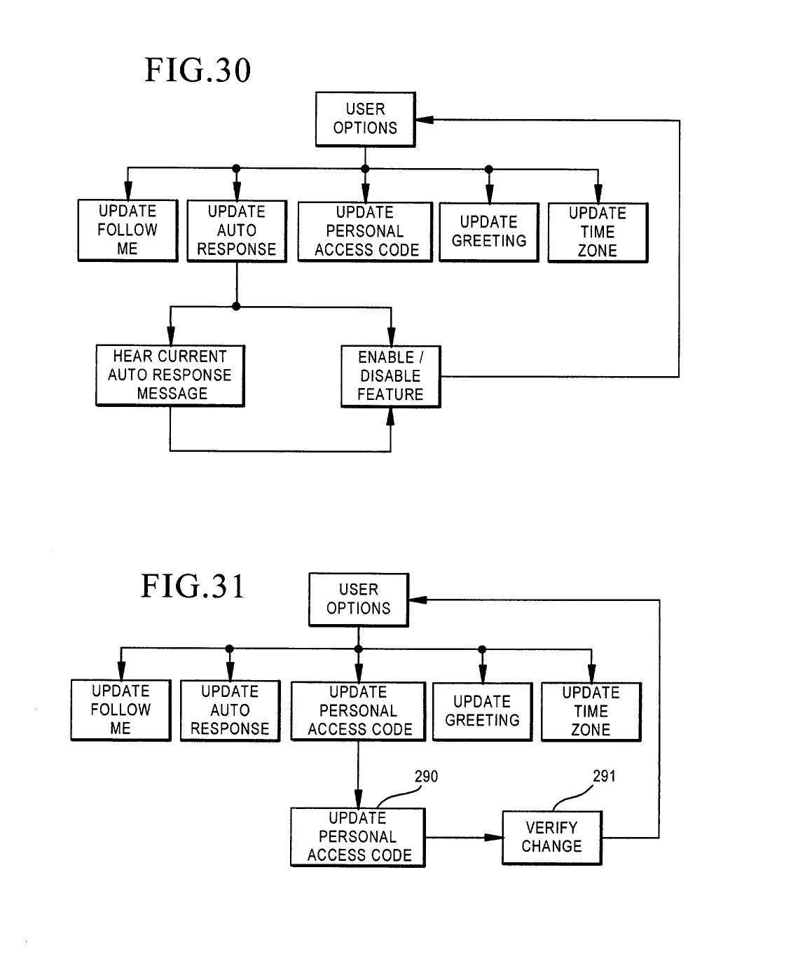

In FIG. 30, the user has the option to update (change)the automatic response, by hearing the response message and then enabling or disabling the response feature.

Under the option to update the personal access code, in FIG. 31, the user has the opportunity to change his/her personal access code, followed by a confirmation sequence. The personal access code in then verified (confirmed) and the database is updated as shown at blocks 290 and 291 before the user is returned to the start of the options portion.

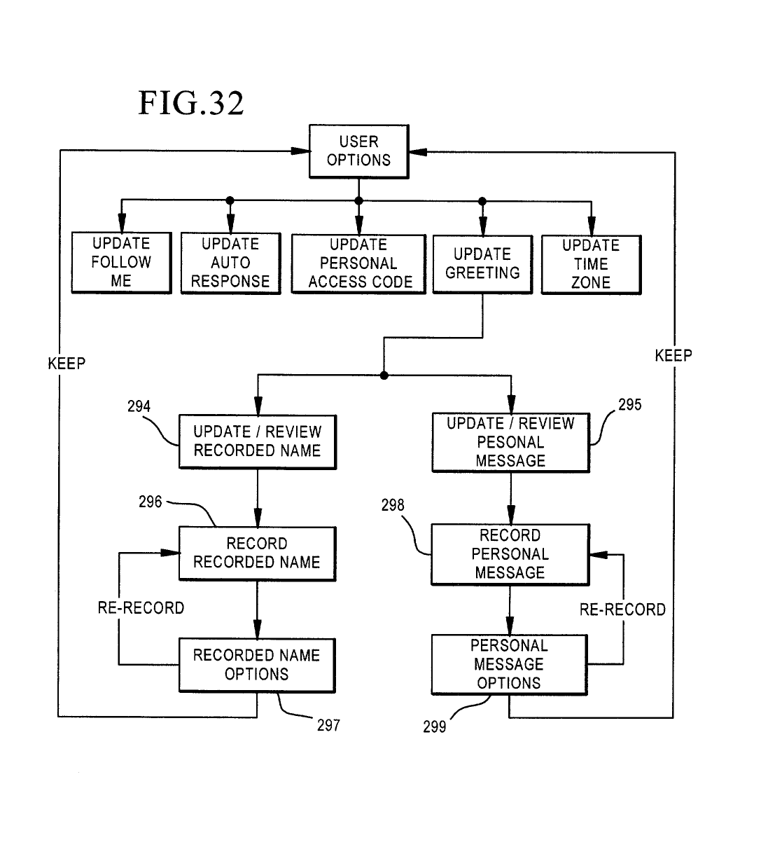

Referring to FIG. 32, the user also has the opportunity to update the greetings presented to a calling party as the calling party enters the system attempting to contact a selected user. The user may review his/her recorded name (block 294) and customize it if desired. Also, the personal message associated with the user's name may be reviewed (block 295) and changed, if desired. The recorded name is played to the calling party before the caller's name is captured and before the “follow me” sequence begins.

The personal message is played when the user is unreachable, or has disabled the “follow me” feature. In each of the above cases, a new name or message can be recorded by the user and then reviewed and confirmed or re-recorded. If the new recorded name/message is confirmed, the user is directed again to the start of the options portion of the telephone portion of the system. The change of recorded name process is shown in blocks 296 and 297, and the change of message process is shown in blocks 298 and 299.

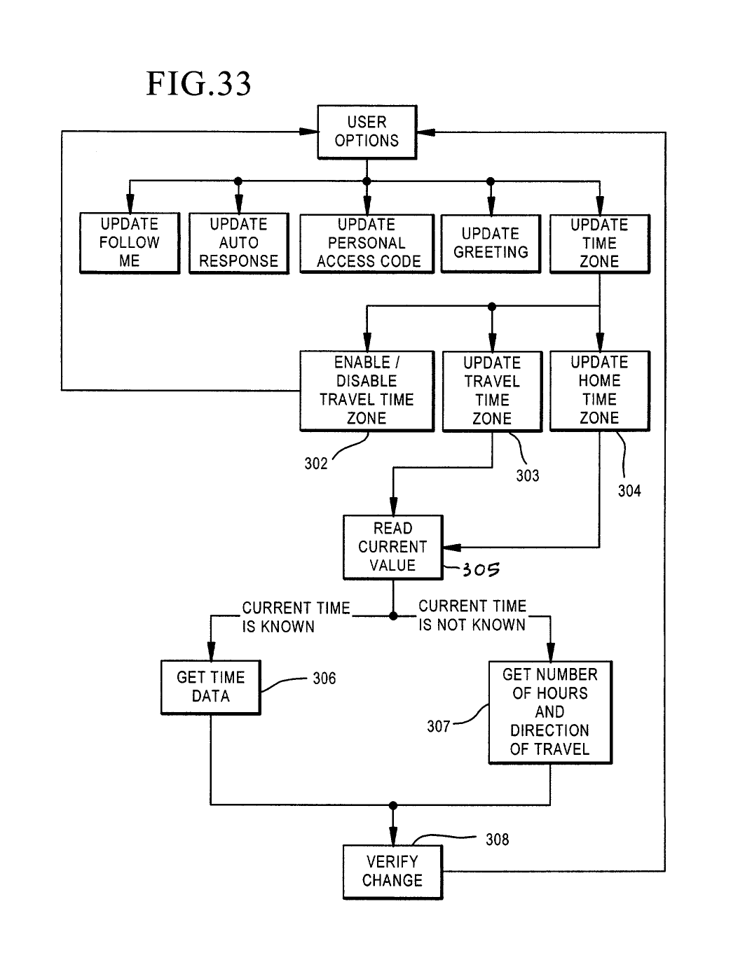

The option to update the time zone preference is shown in FIG. 33. The time zone settings are important in the present system because the time zone information indicates to the system when notification messages, reminders, should be delivered and what date and time values to associate with incoming and outgoing messages. Individual users have the opportunity to enable/disable the travel time zone, as shown at block 302, and to update either their travel time zone or their home time zone, as shown at blocks 303 and 304. In each case, the current value of the time zone is read (block 305); and if the new time is known, the user may simply speak that time, as shown at block 306. Otherwise, the system will prompt the user to ask how many hours and in what direction the user is or has been traveling from his/her home time zone. This is shown in block 307. The change to the new travel time zone value is then verified at block 308 and the user is returned to the start of the options portion of the system.

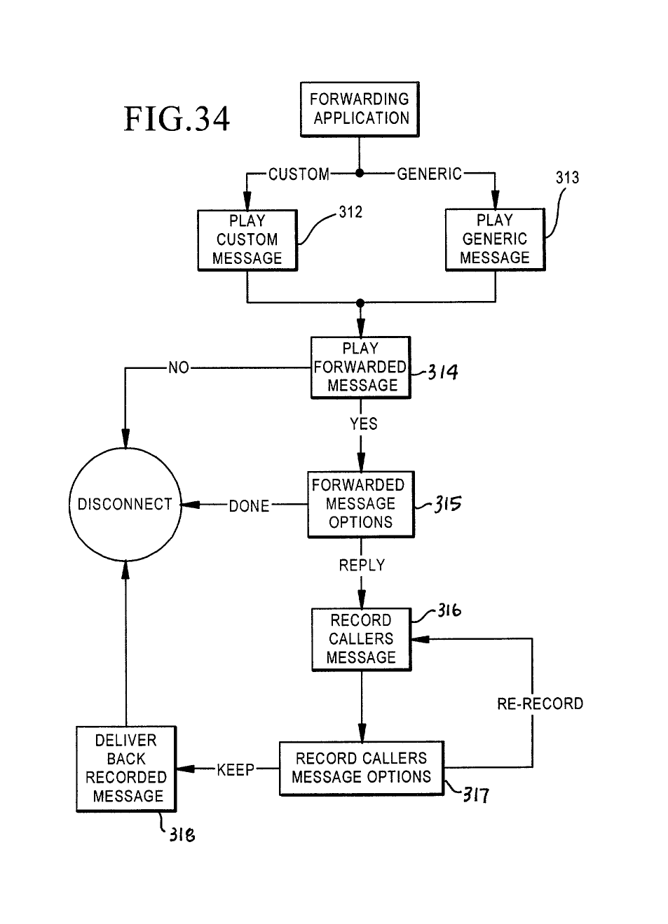

The system of the present invention also includes, from the main module, a general forwarding application process for forwarding messages using the public telephone network. This is shown in FIG. 34. In the forwarding process, voice and E-mail messages can be forwarded to anyone with a telephone, and a reply can be sent back to the originating user within the system who has forwarded the message. When the recipient of the forwarded (voice/E-mail) message answers the phone, they are prompted with a custom greeting (block 312), including the individual user's recorded name (the name of the individual forwarding the message), along with an option to listen to the forwarded message.

A generic message is used in the event that no customer recorded personal name exists. This is shown in block 313. The message may then be heard by the recipient (block 314). If the message is not received, the original sender is notified via E-mail and the call is disconnected. If the recipient chooses to reply to the message, the reply is recorded by the system. The recipient message options (block 315) include the opportunity to confirm, review and/or re-record the reply (blocks 316, 317). If the reply is confirmed, the message is delivered back to the individual user (block 318),and the system disconnects.

This completes the telephone (voice) aspect of the communication system of the present invention.

The communication system of the present invention also includes a network (e.g. internet) aspect using visual interface devices. Various devices can be used, as indicated above. Access to the various portions of the system through the visual interface (network) instead of the telephone (voice) is discussed below. The use of the present system for messaging and for intra-organizational communication involving appointments, calendar, tasks, etc is accomplished via the network device, with content being accessed by the visual interface. The network (visual) portion of the present system interacts with the telephone portion through the single system database, which is organized as described above.

Users of the visual system are prompted to gain access to the system for messages, etc., including a request for a user name and a PIN which are validated against information in the database. The profile for the individual user, which includes information about the user such as selected preferences, telephone numbers, etc., is stored on the database server.

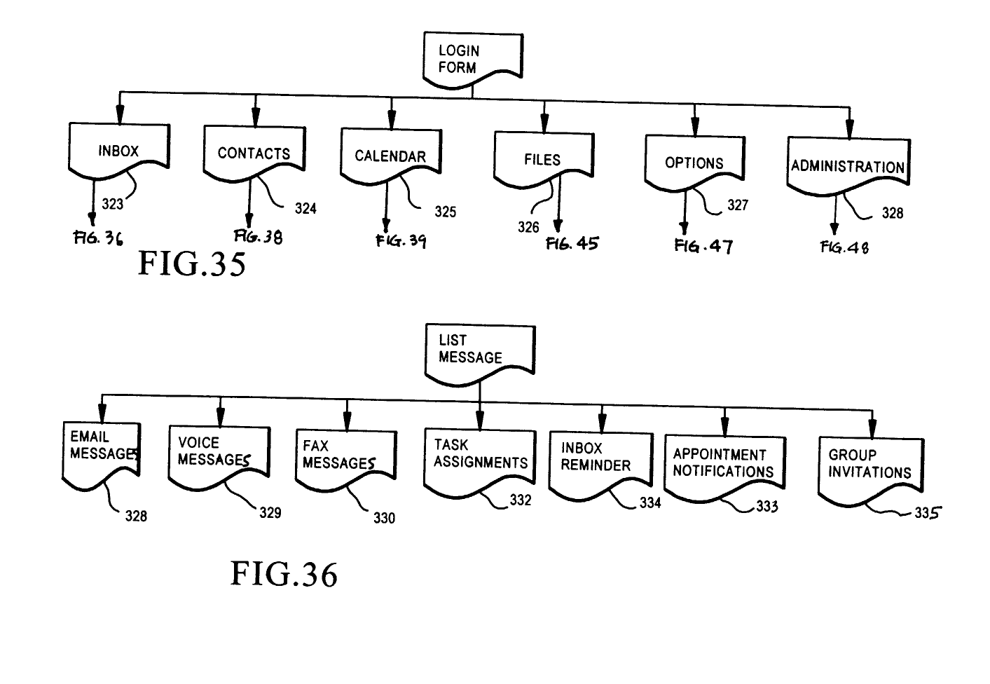

After a successful log-in to the system, the user is directed to a number of different menu items, as shown in FIG. 35. These include inbox, contacts, calendar, files, options and administration portions, referenced by blocks 323-328. Much of the information relative to these options has been discussed above with respect to the telephone portion of the system. However, the visual portion has some additional capability, particularly in the composition of messages and the creation of appointments and task instructions, etc.

The database is the single message store for all the incoming messages, information and events relating to the individual user. As indicated above, messages in the system are maintained in a collection of folders within the single database. Users have the capability, in exercise of folder management, of creating, renaming, deleting, moving, copying and changing folders within the message folder structure in the database relating to themselves. In the visual portion of the system, the messages available to the user are similar to that in the telephone portion, namely, E-mail messages, voice messages and FAX messages (blocks 328-330). These may be originated outside the particular user organization or from within the organization. Intra-organizational messages, including task assignments, appointment notifications, reminders and group invitations (blocks 332-335) are originated and routed within the organization.

Referring to FIG. 36, E-mail messages (block 328) may be viewed and then replied to, forwarded and/or deleted, in the manner discussed above. Voice messages (block 329), once recorded by the telephone portion of the system, may be played, deleted, replied to or forwarded as discussed above.

A FAX message (block 330) can be viewed by the user, although a FAX reply requires a selected FAX number, which is obtained from the system database. The user may reply by composing a message to the original sender, via FAX, or may reply to the sender's E-mail address, or to that telephone number as discussed above. The user through the visual portion of the system may forward the FAX to a FAX machine or an E-mail address. An E-mail address destination will require that the FAX message image(s) be attached to the E-mail message.

Task assignments and appointment notifications (blocks 332, 333) for an individual user can be viewed on the user's visual interface device, and a response can be provided by the individual user to the originator of the task and the originator of the appointment, accepting or declining, as desired by the user. Accepting the task creates an entry on the user's task list and a calendar event with a due date and time, for the individual user in the system. For an appointment invitation, the acceptance of the invitation is delivered via E-mail and the appointment event is added to the user's calendar. System reminders (block 334), originated by the individual user will appear to the user like an appointment in the user's calendar. For instance, creating a “reminder” for a specific message at a specific date and time will create an entry in the reminder queue for delivery on that date and will show the event in the calendar portion.

With respect to group invitations (block 335), the user may invite other users through the visual portion to join a group, if the user has the right, which is known by the system processor, to manage such a group within the user organization. The message from the organizing user is placed in the invited user's inbox, who may accept or decline the invitation. Accepting the invitation to a group allows the user to share and view other members' calendars, contacts, files, etc. relative to that subject matter.

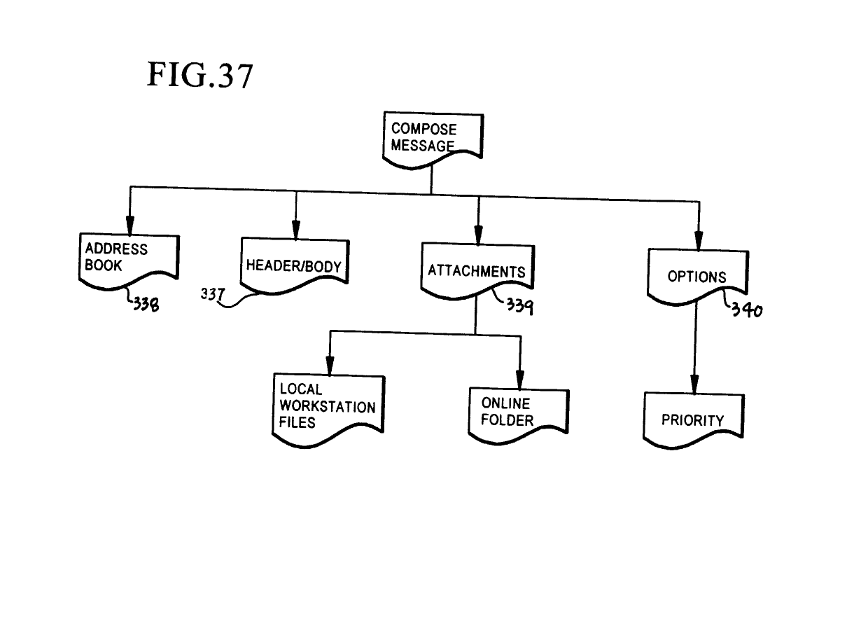

With the visual interface, messages are composed as shown in FIG. 37. The option to compose a new message is available throughout the present system. The message will include a header/body portion with a conventional E-mail message body. This is shown in block 337. The user is able to select one or more names from his/her contact address book in the database (block 338), adding recipients as desired. The user will be able to attach one or more files to the message (block 339) from the network device or from files stored in the database for the individual user. Options (block 340) relative to the message include indicating the priority for the message and a delivery method choice of E-mail or FAX.

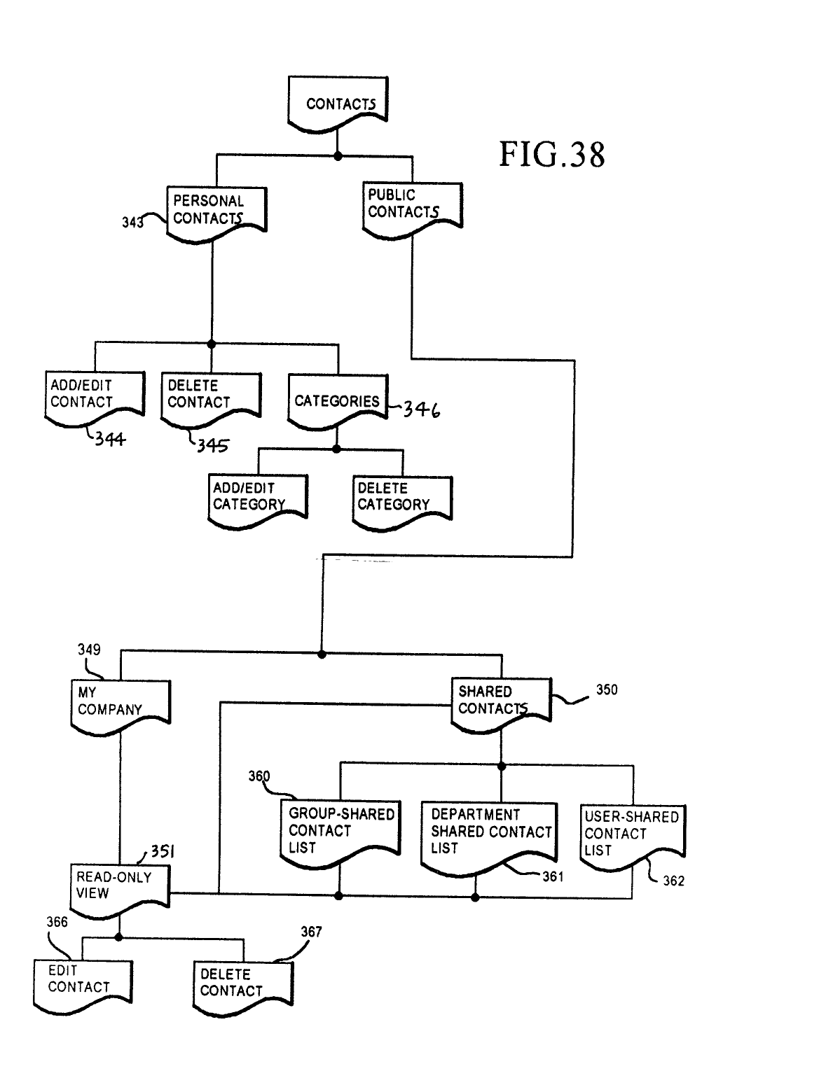

FIG. 38 shows the organization for contact information using the visual portion of the system. The personal contacts page 343 will be a default view, and will typically show the first and last name, the company name, personal category, phone number and E-mail address. Users have the opportunity to sort the personal contacts by clicking on the particular desired column header. Contact information is protected as private by the system by default, such that the only person who can actually see the contact information via the visual interface is the user. The user has the opportunity to add/edit personal contacts (block 334), delete the contact (block 345) or to arrange contacts in his/her address book into logical categories (block 346) that may be formed or deleted by the user.

Public contacts are either other system users within the user's organization (block 349), or those contacts which are shared by other users in the original user's department in the organization, or with users in other organizations (block 350). For a shared contact, the user has authority over whether the shared user has full, read-only (block 351) or no access to the records. The shared contacts can be with a particular group, a department or particular designated individual users. The list of each group is lumped as shown at blocks 360-362. The information available will be the first and last name of the contact, the company name of the contact and the phone number and E-mail address of the contact. Clicking on the E-mail address of the contact will result in the opening of a “compose message” dialog, with the contact's E-mail address already filled in. The contact list can be edited, as shown at block 366, or individuals deleted, at block 367.

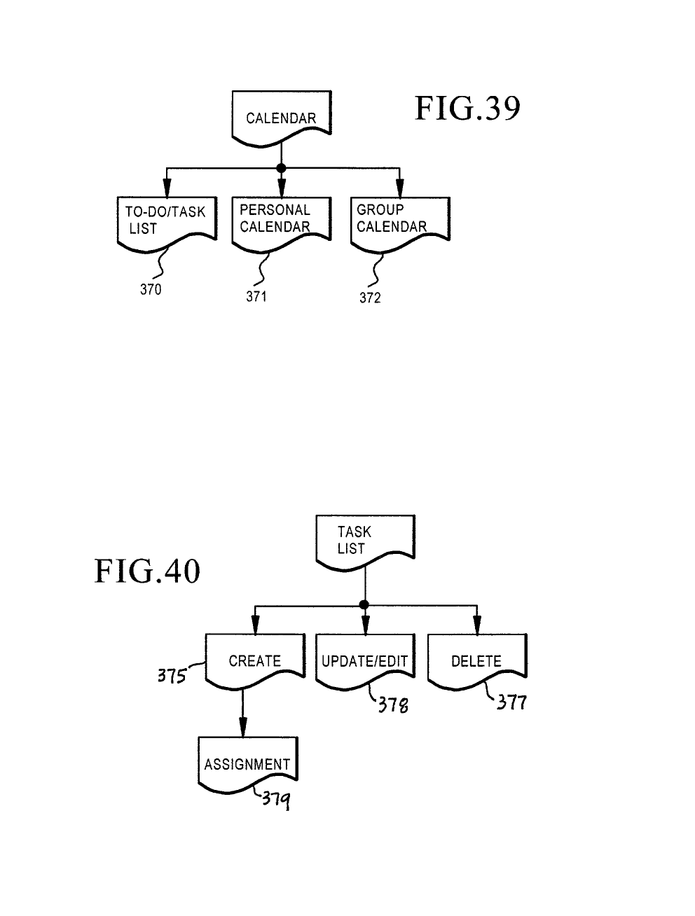

The calendar information from the visual interface is shown in FIG. 39. For tasks, the user is presented (FIG. 40) with a summary task list (block 370) and the status of such tasks, as well their own personal calendar (block 371) showing the current day and links to view activity by week or by month. Users may also view calendar activity for groups of which they are a member (block 372) . Calendar activity also includes appointments and reminders, as discussed below, as well as tasks which are scheduled for completion or delivery on the day being viewed.

FIG. 40 shows the ability of the system to work with tasks through its visual (network) interface. A task may be created (block 375), updated/edited (block 378) and deleted (block 377). A created task may also be assigned to another user (block 379). The creation of a task includes the use of fields for task name, task description, start date and time, due date/time, status, priority, reminder notes and a list of assignees for the task. The assignment of tasks to one or more individual users will include a “pop-up” dialog which will allow users to be added to the task list from the company, department or group directories, or by searching for specific users from within the organization and also within groups in which the user participates.

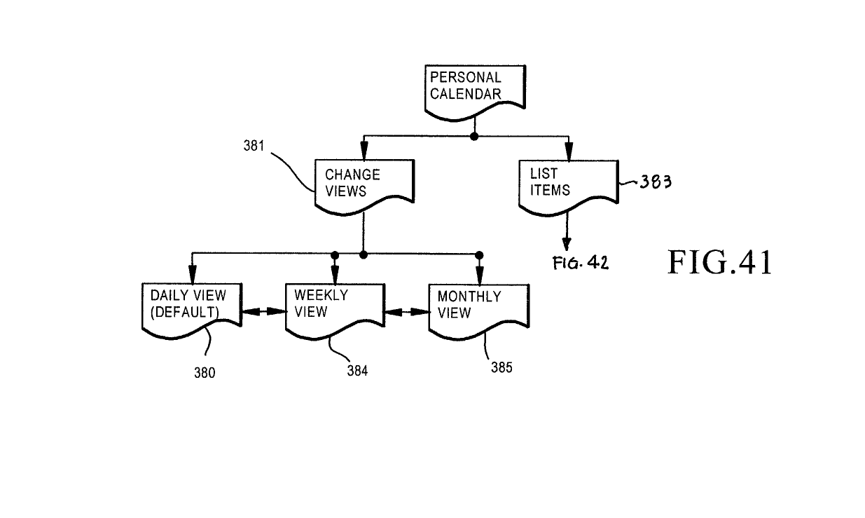

The personal calendar of the overall calendar portion is shown in FIG. 41. The personal calendar will show initially by default a user's daily calendar, as indicated at block 380. The calendar will include the start and end times and the subject for all appointments, reminders and task deadlines. The user has the ability to change the view (block 381) of the calendar to a weekly (block 384) or monthly (block 385) view. The weekly view will show the week which contains the present date, while the monthly view shows the month which contains the present date. Clicking on to a date which is outside the current week or month will result in appropriate weekly and monthly views.

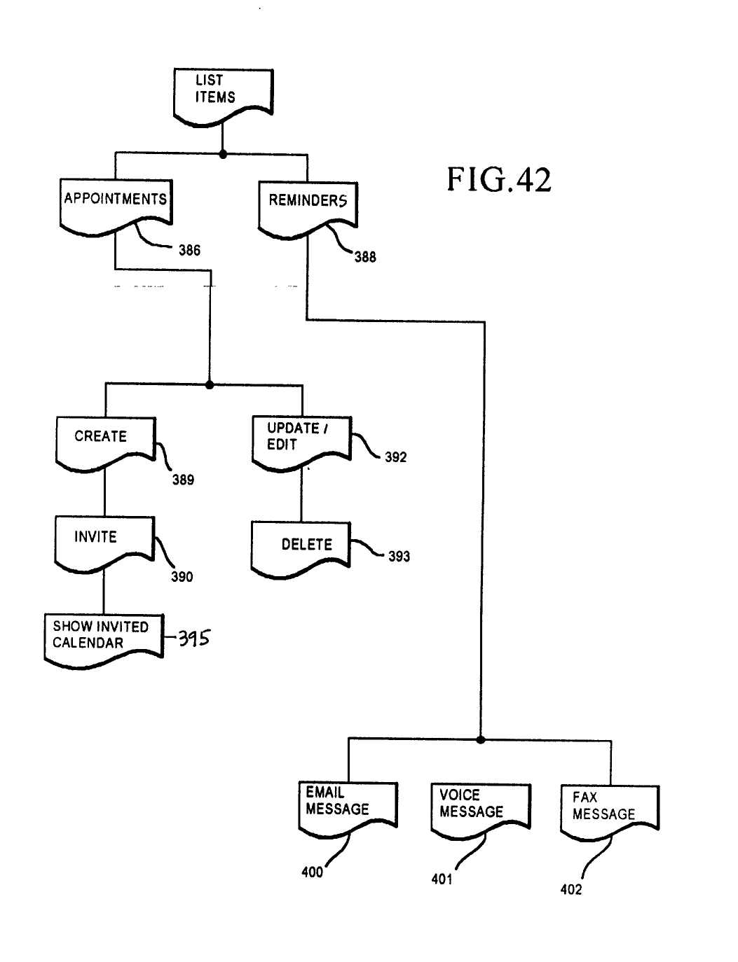

The personal calendar also includes a listing of calendar items (block 383). FIG. 42 shows additional information relative to this listing. As indicated above, appointments and reminders can be listed (blocks 386, 388) in the calendar. Users can create appointments (block 389) in particular time slots, which are shown in specific time increments, e.g. 15 minutes. Appointments can be designated as private or public, which determines whether or not the appointment detail is visible in shared calendar views. The user has the capability to invite other users to the appointment within the same user organization or groups within the organization, as shown in block 390. Invitations to an appointment can be accepted by the invited user in a manner like that for tasks. The invitee has the right to decline the invitation. The invitee's calendar can be reviewed, at block 395, to see whether there are any conflicts in the invitee's calendar. Reminders can also be scheduled for invitees who have accepted.

Users can also update appointments (block 392) which they have created in their own calendar, and notice of the change will be forwarded to all invitees. Users may also delete appointments from their own calendars (block 393) to which they have been invited which will result in a decline of the original invitation.

The calendar also shows the user any reminders which have been scheduled via the user's inbox based on an E-mail (block 400), voice (401) and FAX (402) message received by the user. The calendar portion will provide a link back to the original message entry. An indicator will be used to show if the original entry has been deleted.

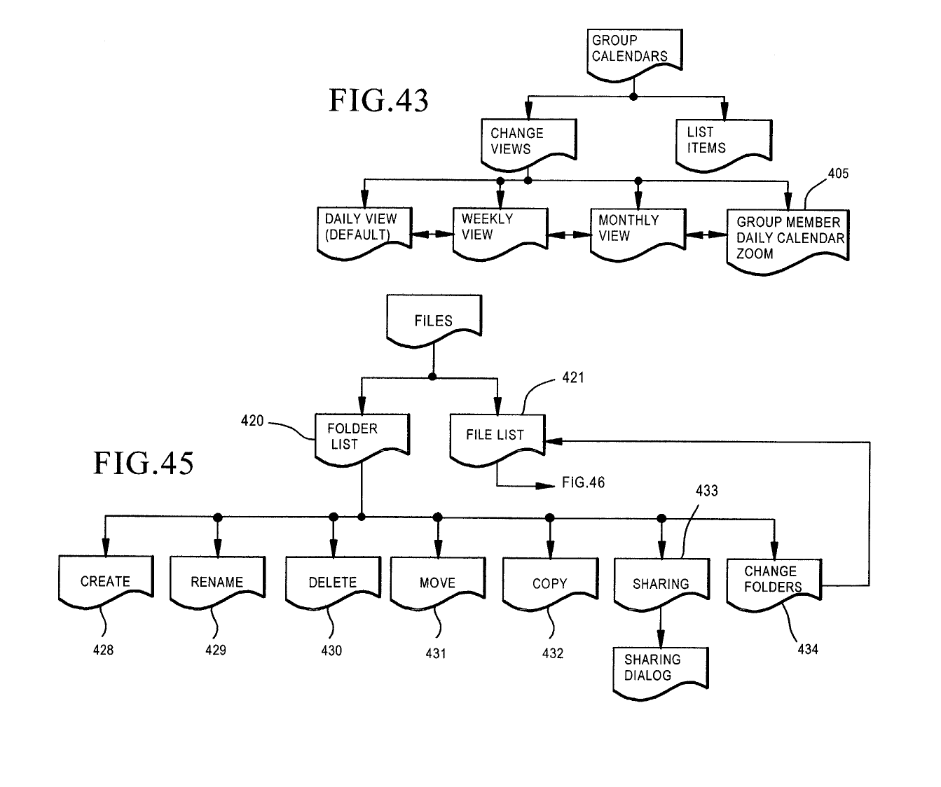

The users in the visual portion of the present system also have the ability to view group calendars of which they are a member (FIG. 43). The group calendar is similar to the personal calendar of FIG. 41 and therefore is not discussed in detail, except that it is directed toward particular groups of which the user is a member. In the group calendar, the individual user does have the additional ability to focus on a single group member's daily calendar and from there navigate through that calendar (block 405), as the user would navigate their own personal calendar. However, users will be able to quickly return to the group calendar page last viewed. When a user is viewing another group member's daily calendar, “private” appointments, that is, meetings which were marked as private when created, will only show up as “busy” time, and no detail will be provided to the other group members or the group administrator concerning private appointments.

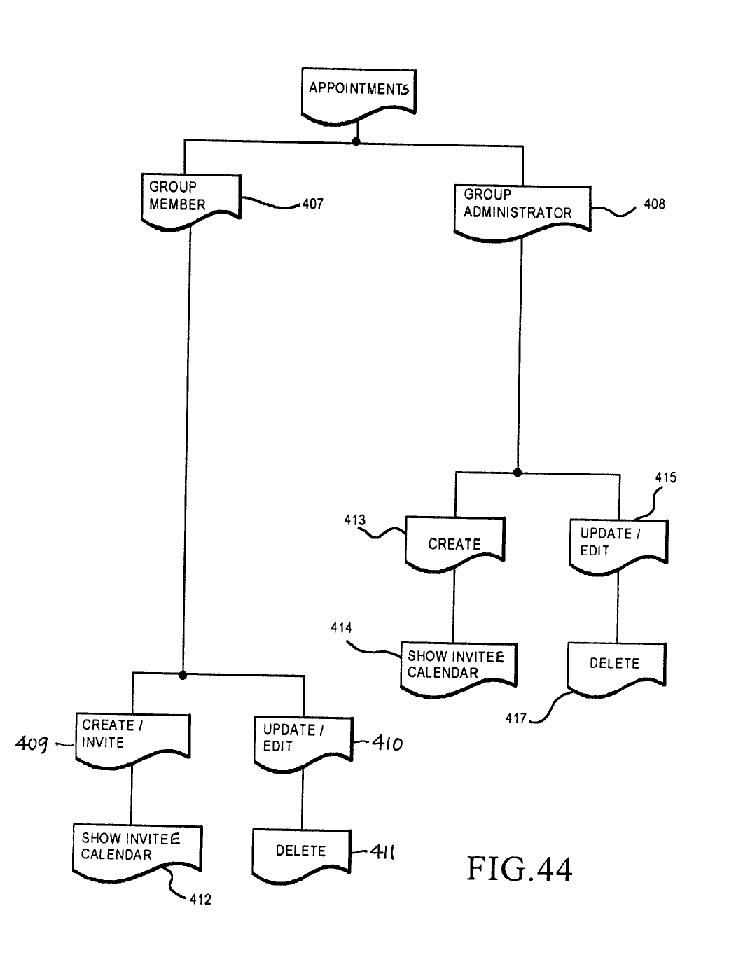

The list of items in the group calendar will be similar to that in the personal calendar, including appointment, task and reminder items. Under appointments, group members as well as group administrators are capable of making appointments. This is shown in blocks 407-408 (FIG. 44).

A group member who wishes to create (schedule) a meeting for one or more members of the group (block 409) will invite those members to the meeting by clicking on the time slot for the desired start time, which is shown in one hour increments. The system indicates to the user any conflicts for any of the possible attendees via a screen that highlights (in red) potential conflicts, as shown at block 412. Invitational appointments will be accepted by those in a manner which is consistent with the assignment/acceptance of tasks. A notification message may be created for any appointment or task, to be delivered at a specified time in advance of the appointment or task deadline. The notice may be delivered to an E-mail address or to a phone number. Appointments can also be updated (block 410) or deleted (block 411) by the group member who created them.

The capability of a group administrator relative to appointments is also shown in FIG. 44. Basically, the group administrator has the same capability as an individual group member concerning scheduling (creating) and administering appointments (block 413); however, the appointment when originating from a group administrator will be deemed to be automatically accepted by the members of the group. Thus, the group administrator has the capability of manipulating the calendars of the group members by directly assigning appointment activity. The members do not have the right to decline. Group administrators have the ability to view the calendars of each member (block 414), as well as the capability of updating and editing the calendars (block 415) and deleting (block 417) the appointments they have created. Notification messages for appointments may be delivered as described above, by E-mail or phone.

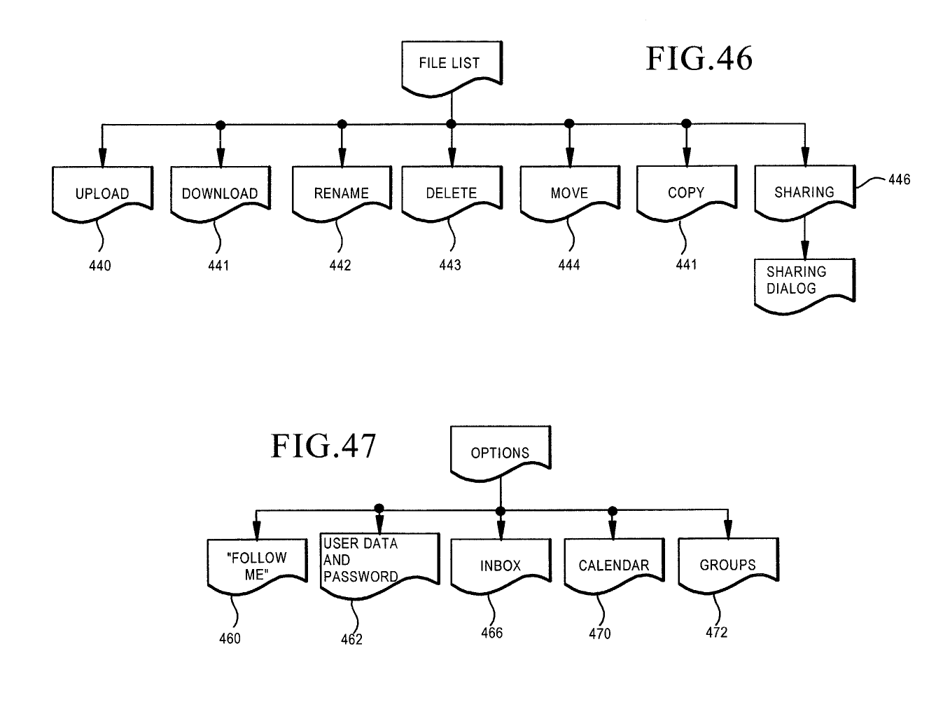

File management techniques in the present system are similar to that of other common file repositories. Referring to FIG. 45, there will be a folder list and a file list, as shown at blocks 420 and 421. Individual users have the ability to create and manage the folders in the database. This includes the ability to create, rename, delete, move, copy, share and change folders (blocks 428-434). Under the sharing function (block 433), only the particular user who creates the folder has the ability to change access to the folder. For the file list (FIG. 46), the user has the ability to upload/download files, rename, delete, move and copy files, as well sharing folders and files with other users (blocks 440-446).

Under the “options” available (FIG. 47) through the visual portion of the system, the user has the ability to set a “follow me” sequence or a schedule of numbers to be dialed by the system when a calling party is attempting to reach a user, as described above with respect to the telephone portion. This is shown in block 460. In the embodiment shown, as indicated above, users have the ability to specify six numbers in the “follow me” sequence. The user also has the ability to create and enable/disable a database “screening” list from which a matching telephone number for a calling identification number must be obtained. If no match occurs, the telephone portion will then redirect the calling party to voice mail.

The user, under options through the visual portion, can also change their password as well as other user relevant data, as shown at block 462. The user also has the capability through the inbox portion (block 466) of the options to create and then enable or disable an automatic response message which is transmitted to the sender of every E-mail message to the user. The system can also be configured to retrieve electronic mail from external messaging sources and have the message stored in the present system database, either in lieu of or in conjunction with the external source.

With respect to the calendar under the options portion (block 470), users have the ability to specify home time zone and the travel time zone as described above with respect to the telephone portion of the system. Users also have the ability through the options portion of the program to make changes to information concerning groups of which they are a member (block 472). Users may create new groups of their own and edit information about groups for which they are responsible. This includes the ability to add (invite) or delete members from the group, as well as giving administrative authority to other group members. Users may also leave groups in which they are currently participating or they may request to join groups within their organization or to join groups designated as public by the owning user.

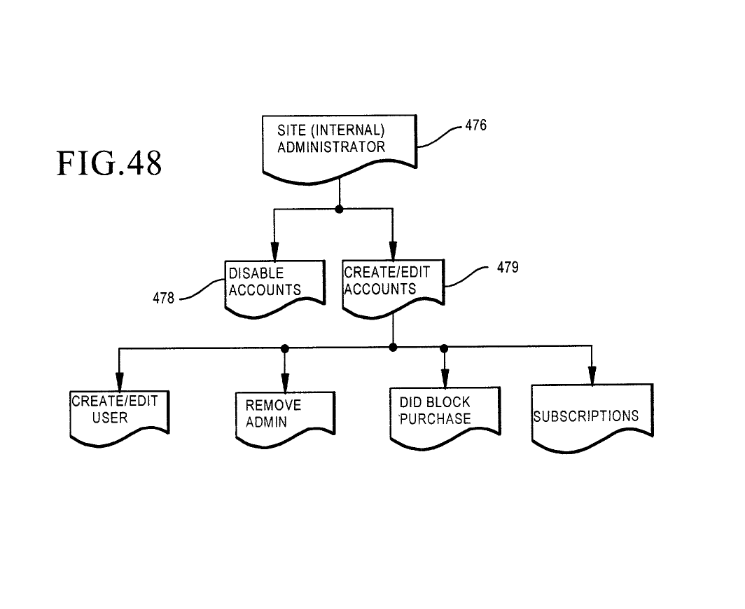

FIG. 48 provides system flow information and control for the administration of the system. Administration includes levels for site administrators (block 476), which are internal system administrators, and company (organizational) administrators. A site administrator as access to the records of the participating organizations associated with the site and has the authority to disable particular accounts, as shown at block 478, and to create new accounts and/or edit existing accounts (block 479). The site administrator has control over the functionality of the system for each organization associated with the system site. While a site administrator may make changes at all levels of all organizations associated with a particular site, company administrators have only the authority to control the system relative to its operation for their particular organization. The site administrator can create or edit an existing user's data, purchase blocks of telephone numbers for the system and allocate blocks of phone numbers to individual users within a specific organization. This may result in companies having access to contiguous blocks of phone numbers.

Hence, a comprehensive, integrated communication system has been described which has both a telephone portion and a visual interface portion for entry into and access to the system. The system provides a complete integration of voice, E-mail and FAX messaging, as well as the ability of the user to respond and reply to those messages via various communication modes. The system also includes a complete internal time and communication organizational system involving both personal and public calendars for tasks, appointments and reminders. The visual and telephone portions of the system are related to each other through a single database. The capability of the present system can be applied to an individual subscriber as well.

Although a preferred embodiment of the invention has been disclosed here for purposes of illustration, it should be understood that various changes, modifications and substitutions may be incorporated without departing from the spirit of the invention, which is defined by the claims which follow.

What is claimed is:

1. A communication system, comprising:
means for recognizing an incoming telephone call and routing it to a selected user in the subscribing organization;
means for receiving a telephone message and routing it to a selected user in a subscribing organization;
means for recognizing an incoming e-mail message and routing it to a selected user in the subscribing organization;
means for recognizing an incoming FAX message and routing it to a selected user in the subscribing organization;
means enabling users in the subscribing organization to respond to telephone calls, and telephone, E-mail and FAX messages directed to them;
means permitting a user in the subscribing organization to communicate with other users in the subscribing organization regarding possible appointments and tasks within the subscribing organization;
means for connecting the system to a global computer network so that users in the subscribing organization have access to the communication system via said network;
processing means for maintaining operating control over the communication system; and
a single database means for storing data relating to the communication system.

2. The system of claim 1, including means for accepting a telephone call from a calling party by a called user in the subscribing organization and for connecting the called user with the calling party upon acceptance of the call by the called user.

3. The system of claim 1, including means for checking the status of the system upon receipt of a telephone call and for disconnecting the telephone call if the system is not functioning properly.

4. The system of claim 2, wherein the system receives the telephone number of the called user and also the telephone number of the calling party.

5. The system of claim 1, including means for following the location of a called user through a selected sequence of telephone numbers previously identified by the called user.

6. The system of claim 5, wherein said selected sequence of telephone numbers is stored in the database.

7. The system of claim 1, including means enabling the user to access messages directed to said user by voice recognition or activation of a selected key on a touch tone telephone following completion of a user validation process.

8. The system of claim 1, wherein a user can request an appointment or a task for at least one other user in the subscribing organization.

9. The system of claim 1, wherein the system has the capability of providing reminders to users concerning previously scheduled appointments and tasks involving said users.

10. The system of claim 1, including means permitting a selected user recipient of an E-mail message to send an E-mail reply to the sender of the message, to forward the message to another E-mail address, or to forward the E-mail message to a FAX machine.

11. The system of claim 1, including means permitting a called user to reply to a voice message by voice or by E-mail, or to forward the voice message to E-mail or to another telephone.

12. The system of claim 1, including means permitting the selected user recipient to reply to a FAX message by voice, or by E-mail, or to forward the FAX message to an E-mail address or to a FAX number.

13. The system of claim 1, wherein appointments accepted by a user will be scheduled in a calendar portion of the system associated with said user.

14. The system of claim 1, wherein task assignments accepted by a user will appear in a task list portion of the system associated with said user.

15. The system of claim 1, including means permitting users to initiate establishment of a group within the subscribing organization and to invite other users in the subscribing organization to participate therein.

16. The system of claim 1, including means permitting users to initiate establishment of a group which includes members from without the subscribing organization.

17. The system of claim 15, wherein group invitations which are accepted will result in a notification being sent back to the initiating user and will result in the establishment of a group calendar and a shared contact list accessible by all members of the group.

18. The system of claim 9, including means permitting a user to access all reminder messages for said user present in the database.

19. The system of claim 1, including a contact portion in the database accessible by users in the subscribing organization containing information concerning each of the users in the organization.

20. The system of claim 1, wherein the contact portion includes information concerning individuals outside of the organization.

21. The system of claim 19, wherein said information includes an E-mail address, a FAX number and telephone numbers.

22. The system of claim 19, including means permitting a user to update all information about said user in the communication system, including means for changing the time zone of the user.

23. The system of claim 22, including control means for controlling access to said user based upon the time zone in which said user is located.

24. The system of claim 21, wherein the time zone location of said user may be changed by said user speaking the actual time where said user is located.

25. The system of claim 22, wherein the time zone location of said user may be changed to a new time zone location by said user indicating the number of hours and direction traveled from a previous time zone location .

26. A communication system, comprising:
means for recognizing incoming telephone calls and telephone, E-mail and FAX messages to a selected user in a user organization and routing said calls and messages to said selected user;
means for storing said messages in and retrieving said messages from a single system database;
means enabling said selected user to respond to said messages; and
means in the database for co-relating messages from a sending party with information in the database concerning said sender and providing said information to said selected user.

27. The system of claim 26, wherein all the messages are stored as separate records in the database, but are related based upon preselected criteria.

28. The system of claim 27, wherein the preselected criteria is association with an individual user.

29. The system of claim 26, including means for establishing appointments and tasks involving selected users within the user organization and for establishing and maintaining calendar information for said users based on acceptance of appointments and tasks, said calendar information being stored and maintained in the database, integrated with said message information relative to each said user.

30. The system of claim 26, including means for connecting a telephone call from a calling party to a called user in the user organization, following acceptance of the telephone call by the called user.

31. The system of claim 26, wherein individual users have access to the communication system via a network connection.

31. A communication system, comprising:
means for recognizing incoming telephone calls and telephone, E-mail and FAX messages to a selected user in a user organization and routing said calls and messages to said selected user;
means for storing said messages in and retrieving said messages from a single system database;
means enabling said selected user to respond to said messages; and
means for storing information concerning users in the user organization, and other selected contact individuals, in the system database, wherein said stored information is related to other selected information in the database by an identification of the user or other contact individual associated with said stored information.

33. The system of claim 32, wherein incoming messages are indicated to be coming from an identified user or a contact individual, and wherein the related information in the database is available to the selected user for reply to the incoming messages.

34. The system of claim 32, wherein the stored information includes the E-mail address, telephone number and FAX number of the identified user or contact individual.

35. The system of claim 32, wherein all messages are stored as separate records in the database and wherein the records are integrated in accordance with preselected criteria.

36. The system of claim 32, including means for establishing appointments and tasks involving selected users within the organization and for establishing and maintaining calendar information for the users in the organization, based on acceptance of said appointments and tasks by said users, wherein said calendar information for each of the users is integrated with the messaging information in the system database.

37. The system of claim 33, wherein individual users have access to the communication system via a network connection.

38. A communication system, comprising:
means for recognizing incoming telephone calls, and telephone, E-mail and FAX messages to a selected user in a user organization and routing said messages to said selected user;
means for storing said messages in and retrieving messages from a single system database;
means enabling said selected user to respond to said messages;
means for receiving and connecting an incoming telephone call to a called user, upon acceptance of the call by the called user; and
means for establishing and maintaining a calendar of accepted appointments and tasks for each user in the organization, wherein the calendar information is integrated with the message information in the system database relative to each user.

39. The system of claim 38, wherein each item of calendar information is stored as a separate record in the database, the individual records being connected together in accordance with preselected criteria.

40. The system of claim 38, wherein the calendar includes reminders, personal appointments and other events relating to the calendar schedule of the individual users.

41. The system of claim 38, wherein calendar information is related to the message information in the database on the basis of a user's identification.

42. The system of claim 38, wherein users in the organization have access to the communication system via a network connection.

43. A system for updating time zone information for use in a communication system involving various modes of communication relative to individual users in an organization, comprising:
means in a system database for maintaining the time zone of the location of the individual users in the communication system;
means for controlling the routing of messages to individual users based on the time zone location of the users, in accordance with predetermined criteria; and
means for establishing a new time zone for a user, wherein the controlling means thereafter controls the routing of messages based on the new time zone.

44. The system of claim 43, including means for entering the identity of a new time zone location for said user, wherein the controlling means thereafter controls the routing of messages to said user based on the new time zone.

45. The system of claim 44, wherein the entering of the identity of the new location is by voice.

46. The system of claim 44, wherein the entered time zone location is the name of a city or an airport code.

47. The system of claim 43, wherein the new time zone is established by said user indicating the number of hours and direction traveled from a previous time zone location.
